(19) United States
(12) Patent Application Publication
(10) Pub. No.: US 2016/0314471 A1
(43) Pub. Date: Oct. 27, 2016

(54) Aberrant and Diminished Activity Detector Apparatuses, Methods and Systems

(71) Applicant: FMR LLC, Boston, MA (US)

(72) Inventors: Evan Gerber, Cambridge, MA (US); Ronald M. Raikula, Boston, MA (US)

(21) Appl. No.: 14/696,350

(22) Filed: Apr. 24, 2015

(51) Int. Cl. G06Q 20/40; G06Q 20/32

(52) U.S. Cl. CPC G06Q 20/4016; G06Q 20/4014; G06Q 20/3224

(57) ABSTRACT

The Aberrant and Diminished Activity Detector Apparatuses, Methods and Systems (“DAD”) transforms abnormal financial or behavioral pattern and enrollment request message inputs via DAD components into alert outputs that may be sent to trusted parties or caregivers, in order to reduce and prevent fraudulent financial transactions that target the elderly or impaired individuals. A subject is enrolled in the DAD system via an enrollment component via enrollment information provided by one of the subject and an observer. The DAD system determines abnormal transaction indicators for the subject from at least one of: historical financial transaction patterns of the subject, abnormal behavior patterns of the subject and predictive indicators derived from historical fraudulent financial data of a population. Alarm thresholds based on the abnormal transaction indicators are determined. When an indication of a financial transaction involving the subject is obtained via a monitoring component, the DAD system determines an alert level for the financial transaction by comparing details of the financial transaction to the transaction alarm thresholds, and transmits an alert to an enrolled observer in accordance with the determined alert level.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address Fraud Detection and Prevention, and more particularly, include Aberrant and Diminished Activity Detector Apparatuses, Methods and Systems.

As such, the present innovations include (at least) the following distinct areas, including: Electronic Communications involving Condition Responsive Indicating Systems that are Responsive to a Particular Sequence of Conditions (with a suggested Class/Subclass of 344/523).

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Some of the earliest signs of diminished capacity in elder adults are changes in their financial behaviors. Children, other relatives and other caregivers seek to identify when such elder adults are nearing a threshold where more involvement or participation would be beneficial. The nature of diminished capacity is that this threshold is often not readily apparent to those who approach or cross it.

Similarly, older adults or others of diminished capacity, often grant access to their financial accounts to select family members and/or other caregivers, or to trusted professionals such as financial advisors or lawyers. This financial access, if unmonitored, creates an opportunity for unethical dealings.

### BRIEF DESCRIPTION OF THE DRAWINGS

Appendices and/or drawings illustrating various, non-limiting, example, innovative aspects of the Aberrant and Diminished Activity Detector Apparatuses, Methods and Systems (hereinafter “DAD”) disclosure, include:

FIG. 1 shows a block diagram for a group of cooperating networked servers illustrating embodiments of an DAD;

FIGS. 2-4 show a datagraph diagram illustrating embodiments of an enrollment and monitoring process for the DAD;

FIGS. 5 and 5B show a logic flow diagram illustrating embodiments of a monitoring and alerting process for the DAD;

FIGS. 6-30 show screenshot diagrams illustrating exemplary screen displays presented by the DAD; and

FIG. 31 shows a block diagram illustrating embodiments of an DAD controller.

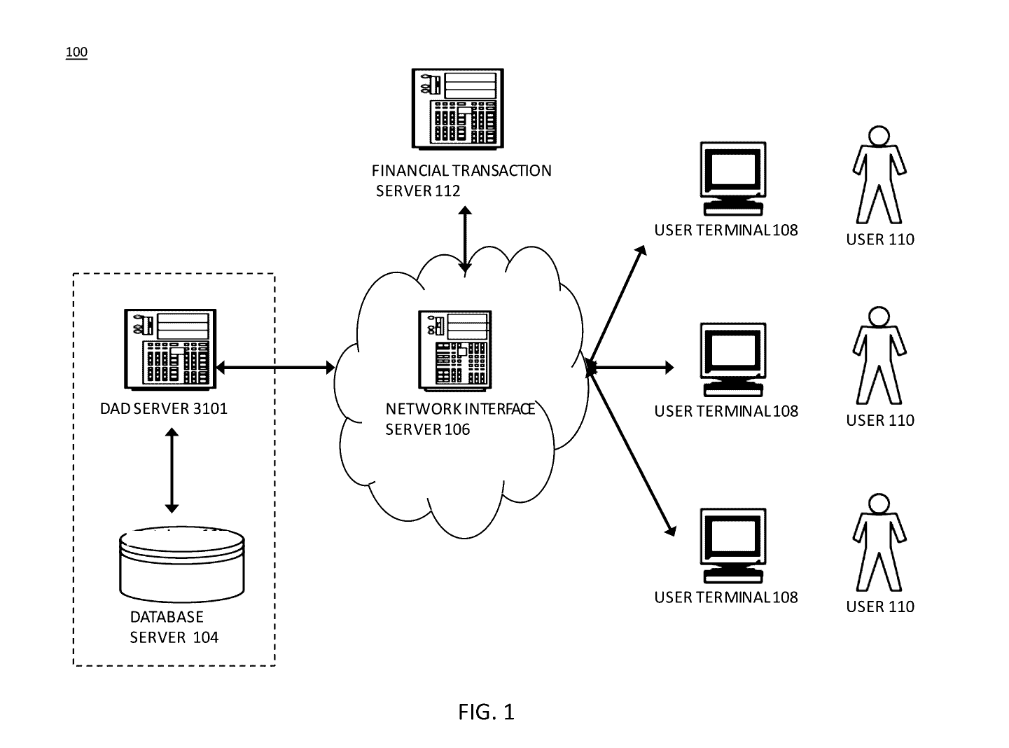

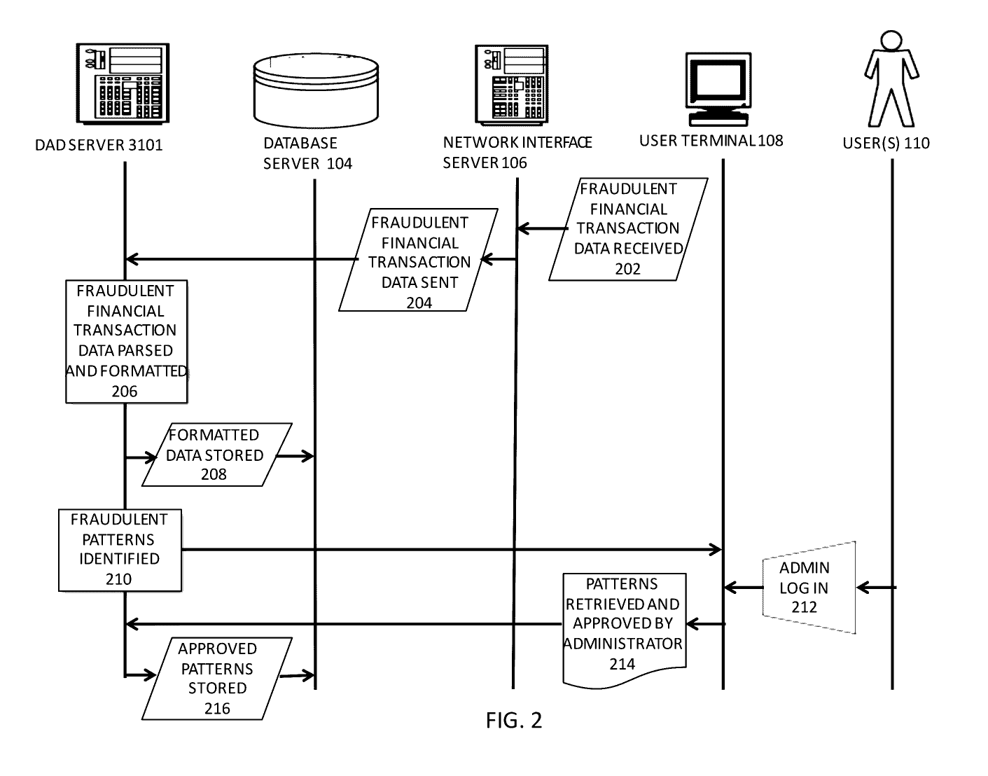

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

The Aberrant and Diminished Activity Detector Apparatuses, Methods and Systems (hereinafter “DAD”) transforms abnormal financial or behavioral pattern and enrollment request message inputs, via DAD components (e.g., Enrollment Component, Financial Transaction and Behavioral Tracking Component, and Alerting Component, etc.), into monitoring conditions and alert outputs. The DAD components, in various embodiments, implement advantageous features as set forth below.

This invention defines a technology platform that monitors financial activities of many types, recognizing patterns, trends, actions, and other telltale signs of diminished capacity. Designated interested parties are notified according to pre-determined rules, which may differ based upon the depth and nature of the relationship. Interested parties may include family, caregivers, or legal representatives.

### Introduction

The DAD system will track changes in the financial patterns of the target individuals (such as, the elderly or individuals of diminished capacity) to identify normal behavior and discern and prevent aberrant/deviating/fraudulent/behavior and transactions involving such target individuals. The system may then relay such discerned aberrant behavior to a chosen guardian (e.g., designated contacts, such as adult children, family members, other caregivers, Account Representatives of affected financial institutions, etc.). The guardian may be a person and/or computer system, and maybe elected and/or selected by the target individual as a designated transaction guardian. The aberrant behavior may include any of physical/emotional/pharmacological-induced anomalous behavior (e.g., intoxication, incoherence, delusional.) that may be temporary, progressive or permanent. Aberrant behavior may likewise include behavioral variations from previous established norms, or individuals with known conditions of diminished capacity such as, age-r or medically-related memory deterioration, the mentally-challenged and the like

The DAD system will tie together families and financial institutions to track monitored individuals' behaviors and protect them from abuse or mistakes arising due to diminished capacity. The tracking of behavior, finances, and other data sources and comparing them against historical and benchmark data is a new way to non-intrusively monitor, analyze, identify and prevent fraud.

Initially, a customer will sign up for the DAD service, and then create accounts for other individuals. The customer can either be the individual being tracked (Subject), or the caregiving individuals (Observers) who will be notified by the DAD system. The system requires at least one Subject and one Observer, and will capture their participant information, as well as user preferences around alerts, and the level of information that the system can access.

The DAD system will then track how the Subject is managing their finances over time, by comparing behaviors against a matching engine that tracks the Subject's behavior, Subject's historical benchmark data, Subject's financial account balances and investment behaviors, and then compares them against historical and benchmark information for the population at large.

The DAD system will perform ongoing analysis of accounts and behavior. If the Subject is behaving within normal parameters, the system will send a regular status message (i.e., e-mail, text message (SMS), or other signaled alert to the Observer informing them of summary behavior. If however, the Subject's behaviors begin to deviate from the norm, the DAD system will determine if the problems are low or high severity. If the problems are low severity, there will be an alert sent through regular channels, such as text or e-mail. If on the other hand, the problems are high severity, then the system will escalate based on severity and time sensitivity. Three exemplary tiers of alert severity may, for example, be (in order of increasing severity) (i) e-mail/text/app alert/web notification messages, (ii) a phone call from a financial institution representative to a designated Observer, and (iii) physical outreach or intervention from a third party, such as the police.

The DAD system supports a number of critical business goals. For instance, it helps facilitate the family conversation required with aging parents by providing non-intrusive means for tracking behaviors and identifying when action needs to be taken, thereby minimizing risk of abuse or theft. By engaging in this manner with caregiver relatives (such as the children of a monitored client), a financial institution can help build relationships with these younger investors, thereby increasing the likelihood that these individuals will develop a sense of fealty towards the financial institution, and thus reducing the likelihood that customers or their caregivers will transfer funds to another financial institution.

The DAD system supports the goals of elder and impaired customers who typically seek fiscal responsibility, but may not recognize when they need assistance. It also allows Subjects to trust Observers to whom they've granted financial access, but of whom they may still be wary without proper oversight. The checks-and-balances approach of the DAD System and its various participants insures that no one individual may attempt fraud against the financial accounts of a Subject without other responsible parties noticing.

The DAD system likewise supports the goals of Observers, such as siblings or mature children who typically want to know when the Subject needs additional help, and who typically want reassurances that whomever has access to the financial accounts of the elder customer is operating appropriately.

Unlike with fraudulent transaction in the population at large, changes in fiscal responsibility for the elderly and impaired individuals may include a variety of addition aberrant behaviors, such as: not paying credit card or utility payments on time, making double payments or payments for an inappropriate amount, not cashing checks promptly (or other income issues), inappropriate revisions to automated bill payment rules, replacement of checkbooks (or safety deposit box keys), unprompted password changes, checks being cashed out of sequence, changes in financial management activities, stopped checking balance, higher than normal (or redundant) calls to customer service or branch visits, confused or belligerent customer service interactions, unusual investment activities, acting secretively about money, changes in purchase or other non-financial behaviors, redundant purchases, loss of prudence/self control, unusual spending increases and purchases, unusual or inappropriate investment choices, unusual purchases or donations, transfers to unmonitored accounts, customer service indications (scared whisperings, etc.), changes to service expenses, location based discrepancies (i.e., patient is bedridden yet making ATM withdrawals or makes simultaneous purchases uses two different credit cards at two different locations), purchasing things they cannot use (i.e., access to gym), abrupt changes in power of attorney or will disposition, cancellation of phone service, not logging into their financial account for an extended period of time, providing access to a new “Friend” with disproportionate access to the subject's funds, or changes in disposition on social media sites or the like.

In response to monitored or detected aberrant financial transactions or other aberrant behaviors, based for example on one or more of the foregoing occurrences, the DAD System may issue an alert to Observers or other parties. The level of the alert may determine the specific course of action taken. For example, a Low Severity Alert may be issued when the financial transaction amounts in question are small or the behavior in question unusual but not erratic. A High Severity Alert may instead be issued when the financial transaction involves large amounts, significant risk of penalty, or irrevocable change. High Severity Alerts may result in changes that lock the party attempting the transaction out of their affected accounts, without prior consent of such party, until such time as the validity of the financial transaction can be manually verified.

The DAD System may use a plurality of programmed algorithms to perform the enrolling, monitoring and alerting functions described herein. The algorithms may in turn depend upon a variety of variables and formulae as described herein

Various automated fraud detection and alerting functions described herein may depend on the detection of various event triggers. For example, an alert may be triggered if the preceding “x” months of financial activity of a subject meets established criteria derived from the population at large for aberrant behavior. An alert may be triggered if there is introduction of new individuals with financial control submitted by the subject. An alert may also be triggered when subject behaviors match typical elder abuse/deterioration patterns

In order to establish alarm or alert thresholds, such algorithms may include a peer comparison baseline, in which the subject's financial activity history, prior history of payments, patterns of contact with financial institutions (i.e., reviewing account balances), account transfer history, investment/purchasing choices and style, communication style with representatives or caregivers, purchasing locations and means of payment used (i.e., using different credit cards) are all modeled and stored for later comparison.

The algorithms employed by the DAD System may likewise use trend analysis to determine aberrant subject behaviors that may be indicators of a fraudulent transaction. Such trends may include the number of overpayments, minimum payments, partial payments and double payments that the Subject historically submitted, the credit score of the subject, and the Subject's historical timeliness of task completion (such as bill payment, time to cash received checks).

The algorithms employed by the DAD System may also include fraud pattern detection schemes based on historical fraudulent data from the population at large. The DAD System may use the historical patterns of fraudulent transactions, along with the previously described event triggers, peer comparison baselines and trend analysis to generate predictive indicators for fraudulent transactions involving the subject, as described in more detail herein below.

The DAD System may provide further general functionality such as customer service messages for requesting extra data collection and password generation and management features for the financial accounts of the Subject.

### DAD

FIG. 1 shows a block diagram illustrating networked embodiments of the DAD network environment 100.

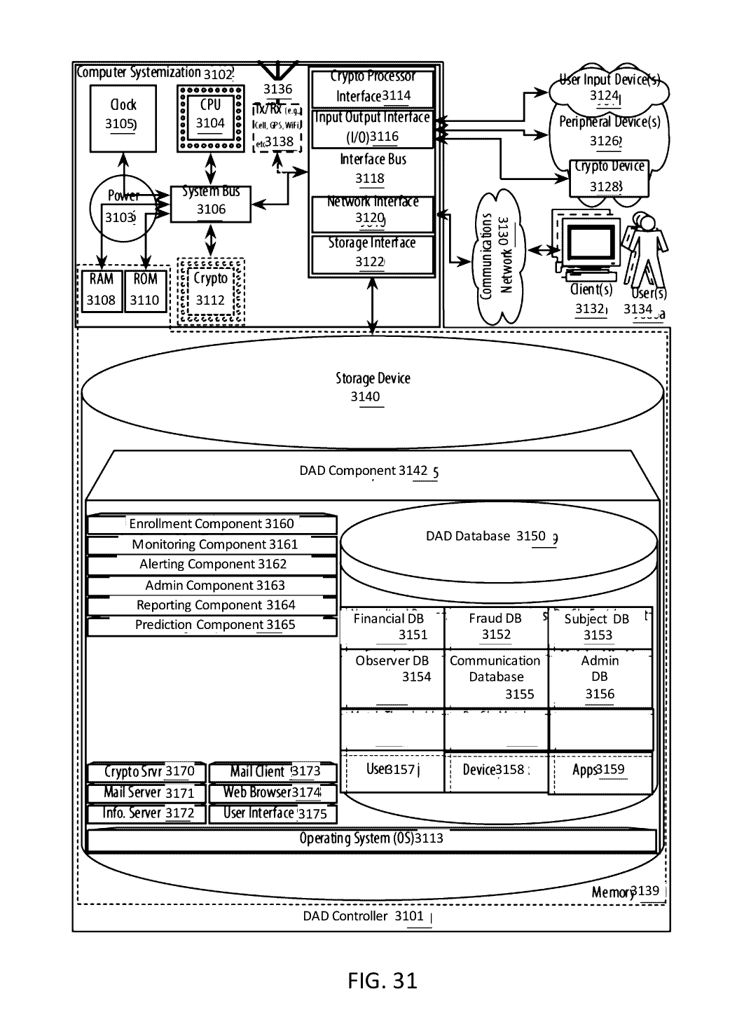

The environment 100 may include a DAD Server 3101, the functions and components of which described in detail below with respect to FIG. 31. The DAD Server 3101 may comprise one or many servers, which may collectively be included in the DAD System.

The environment 100 may further include a Database Server 104, which may be provided to store various information used by the DAD Server 3101 including enrollment data, Observer and Subject profile information, financial transaction data, behavior data and any other data described, contemplated and used herein.

The environment 100 may further include a Network Interface Server 106, which, for example, enables data network communication between the DAD Server 3101, Database Server 104, and User Terminals 108, in accordance with the interactions as described herein.

The environment 100 may further include one or more User Terminals 108, which may be any type of computing device used by users 110. Users 110, in turn, may be Observers, Subjects, programmers, administrators or representatives, as described further herein.

The environment may further include connections to financial transaction servers 112. The Financial Transaction servers 112 may be operated by the financial institution offering the DAD System. Alternatively, or in addition thereto, the Financial Transaction Servers 112 may include financial transaction servers of other financial institutions that process payments, deposits and withdraws, such as credit card companies, banks, credit unions, investment brokers, and payment clearinghouses. Any or all types of financial transaction servers may be employed in conjunction with the DAD System in order to accomplish the functionalities described herein, particularly with respect to monitoring the financial transactions of Subjects for possible indications of fraud. The ability to monitor multiple financial accounts from multiple financial institutions represents a new dimension of fraud monitoring, in which typically on the historical and current transactions of a single account are used to detect possible fraud with respect to that account. The DAD System's additional functionality in this regard represents a technological advancement in the field of network communications by which such network communications are efficiently harnessed to determine fraud involving any and all financial accounts of a Subject through concurrent monitoring of activities across the full spectrum of their account holdings, with the DAD system being agnostic to the financial institution that actually maintains such accounts.

The servers and terminals represented in FIG. 1 cooperate via network communications hardware and software to initiate the collection of data for use in DAD System. the processes involving which will now be described in more detail. One such exemplary process is illustrated in the datagram diagram depicted in FIGS. 2-4.

Turning to FIG. 2, commencing at step 202, fraudulent financial transaction data (as well as other behavioral data) is received by the DAD System via Network Interface Server 106. The historical fraudulent financial transaction data and other aberrant behavior involving the population at large is then sent for analysis to DAD Server(s) 102 (step 204). An example fraudulent financial transaction message 204, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<fraudulent_Financial_transaction_message>
    <timestamp>2020-12-31 23:59:59</timestamp>
    <user_accounts_details>
          <user_account_credentials>
                <user_name>JohnDaDoeDoeDoooe@gmail.com</account_name>
                <password>abc123</password>
                //OPTIONAL <cookie>cookieID</cookie>
                //OPTIONAL <digital_cert_link>www.mydigitalcertificate.com/
JohnDoeDaDoeDoe@gmail.com/mycertifcate.dc</digital_cert_link>
                //OPTIONAL <digital_certificate>_DATA_</digital_certificate>
          </user_account_credentials>
    </user_accounts_details>
    <client_details> //iOS Client with App and Webkit
          <client_IP>10.0.0.123</client_IP>
          <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
          <client_product_type>iPhone6,1</client_product_type>
          <client_serial_number>DNXXX1X1XXXX</client_serial_number>
          <client_UDID>3XXXXXXXXXXXXXXXXXXXXXXXXD</client_UDID>
          <client_OS>iOS</client_OS>
          <client_OS_version>7.1.1</client_OS_version>
          <client_app_type>app with webkit</client_app_type>
          <app_installed_flag>true</app_installed_flag>
          <app_name>_Innovation_Nickname_.app</app_name>
          <app_version>1.0 </app_version>
          <app_webkit_name>Mobile Safari</client_webkit_name>
          <client_version>537.51.2</client_version>
    </client_details>
    <client_details> //iOS Client with Webbrowser
          <client_IP>10.0.0.123</client_IP>
          <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
          <client_product_type>iPhone6,1</client_product_type>
          <client_serial_number>DNXXX1X1XXXX</client_serial_number>
          <client_UDID>3XXXXXXXXXXXXXXXXXXXXXXXXD</client_UDID>
          <client_OS>iOS</client_OS>
          <client_OS_version>7.1.1</client_OS_version>
          <client_app_type>web browser</client_app_type>
          <client_name>Mobile Safari</client_name>
          <client_version>9537.53</client_version>
    </client_details>
    <client_details> //Android Client with Webbrowser
          <client_IP>10.0.0.123</client_IP>
          <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
          <client_product_type>Nexus S</client_product_type>
          <client_serial_number>YXXXXXXXXZ</client_serial_number>
          <client_UDID>FXXXXXXXXX-XXXX-XXXX-XXXX-XXXXXXXXXXXXX</client_UDID>
          <client_OS>Android</client_OS>
          <client_OS_version>4.0.4</client_OS_version>
          <client_app_type>web browser</client_app_type>
          <client_name>Mobile Safari</client_name>
          <client_version>534.30</client_version>
    </client_details>
    <client_details> //Mac Desktop with Webbrowser
          <client_IP>10.0.0.123</client_IP>
          <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
          <client_product_type>MacPro5,1</client_product_type>
          <client_serial_number>YXXXXXXXXZ</client_serial_number>
          <client_UDID>FXXXXXXXXX-XXXX-XXXX-XXXX-XXXXXXXXXXXXX</client_UDID>
          <client_OS>Mac OS X</client_OS>
          <client_OS_version>10.9.3</client_OS_version>
          <client_app_type>web browser</client_app_type>
          <client_name>Mobile Safari</client_name>
          <client_version>537.75.14</client_version>
    </client_details>
    <fraud_data>
          <activityType>mobile</activityType>
          <transactionAmount>$0.12</transactionAmount>
          <lowTransactionThreshold>$3.00</lowTransactionThreshold>
          <highTransactionThreshold>300.00</highTransactionThreshold>
          <withdrawlLimit>50.00</withdrawlLimit>
          <primaryUserLimit>25.00</primaryUserLimit>
          <actualWithdrawalRequest>85.00</actualWithdrawal>
    </fraud_data>
</fraudulent_Financial_transaction_message>
```

The DAD system then parses and formats the received fraudulent financial transaction data (step 206), which data may then be stored in Database Server 104 (step 208) for further pattern recognition analysis.

The DAD server(s) 3101 then identifies patterns in the stored fraudulent financial transaction data. Identified patterns are communicated to system administrators who have logged (step 212) in to a user terminal 108, such patterns transmitted via the network interface server 106 (step 214). All fraudulent transaction patterns that are approved by the administrator are then stored in Database Server 104 (step 216) for use by later described monitoring components and the like.

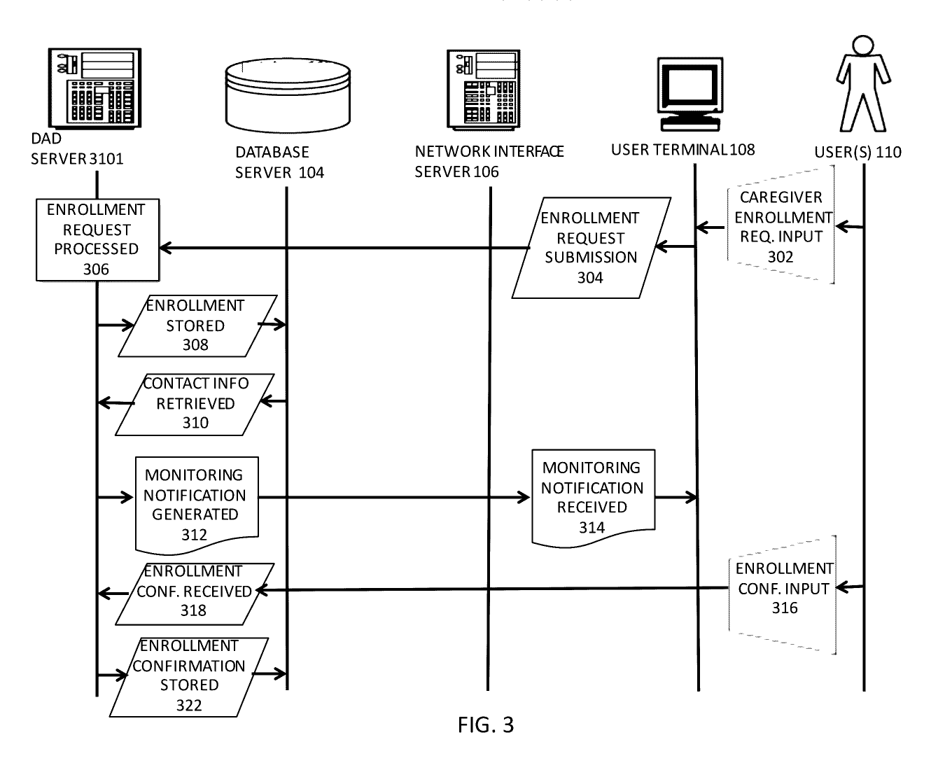

Continuing now to FIG. 3, the process continues to step 302 wherein an Observer (such as a caregiver, a relative or trusted assistant) logs into a user terminal 108 to generate an enrollment request for the Subject (i.e., elder/impaired customer) of a financial institution. The enrollment request is received at network interface server and forwarded to the DAD Server 3101 (step 304). Alternatively and equivalently, a Subject may instead log in and create accounts for trusted Observers.

An example enrollment request message 304, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<enrollment_request_message>
    <timestamp>2020-12-31 23:59:59</timestamp>
    <user_accounts_details>
          <user_account_credentials>
                <user_name>JohnDaDoeDoeDoooe@gmail.com</account_name>
                <password>abc123</password>
                //OPTIONAL <cookie>cookieID</cookie>
                //OPTIONAL <digital_cert_link>www.mydigitalcertificate.com/
JohnDoeDaDoeDoe@gmail.com/mycertifcate.dc</digital_cert_link>
                //OPTIONAL <digital_certificate>_DATA_</digital_certificate>
          </user_account_credentials>
    </user_accounts_details>
    <client_details> //iOS Client with App and Webkit
          <client_IP>10.0.0.123</client_IP>
          <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
          <client_product_type>iPhone6,1</client_product_type>
          <client_serial_number>DNXXX1X1XXXX</client_serial_number>
          <client_UDID>3XXXXXXXXXXXXXXXXXXXXXXXXD</client_UDID>
          <client_OS>iOS</client_OS>
          <client_OS_version>7.1.1</client_OS_version>
          <client_app_type>app with webkit</client_app_type>
          <app_installed_flag>true</app_installed_flag>
          <app_name>_Innovation_Nickname_.app</app_name>
          <app_version>1.0 </app_version>
          <app_webkit_name>Mobile Safari</client_webkit_name>
          <client_version>537.51.2</client_version>
    </client_details>
    <client_details> //iOS Client with Webbrowser
          <client_IP>10.0.0.123</client_IP>
          <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
          <client_product_type>iPhone6,1</client_product_type>
          <client_serial_number>DNXXX1X1XXXX</client_serial_number>
          <client_UDID>3XXXXXXXXXXXXXXXXXXXXXXXXD</client_UDID>
          <client_OS>iOS</client_OS>
          <client_OS_version>7.1.1</client_OS_version>
          <client_app_type>web browser</client_app_type>
          <client_name>Mobile Safari</client_name>
          <client_version>9537.53</client_version>
    </client_details>
    <client_details> //Android Client with Webbrowser
          <client_IP>10.0.0.123</client_IP>
          <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
          <client_product_type>Nexus S</client_product_type>
          <client_serial_number>YXXXXXXXXZ</client_serial_number>
          <client_UDID>FXXXXXXXXX-XXXX-XXXX-XXXX-XXXXXXXXXXXXX</client_UDID>
          <client_OS>Android</client_OS>
          <client_OS_version>4.0.4</client_OS_version>
          <client_app_type>web browser</client_app_type>
          <client_name>Mobile Safari</client_name>
          <client_version>534.30</client_version>
    </client_details>
    <client_details> //Mac Desktop with Webbrowser
          <client_IP>10.0.0.123</client_IP>
          <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
          <client_product_type>MacPro5,1</client_product_type>
          <client_serial_number>YXXXXXXXXZ</client_serial_number>
          <client_UDID>FXXXXXXXXX-XXXX-XXXX-XXXX-XXXXXXXXXXXXX</client_UDID>
          <client_OS>Mac OS X</client_OS>
          <client_OS_version>10.9.3</client_OS_version>
          <client_app_type>web browser</client_app_type>
          <client_name>Mobile Safari</client_name>
          <client_version>537.75.14</client_version>
    </client_details>
    <enrollment_data>
          <activityType>mobile</activityType>
          <RequestorName>John Doe, Jr.</ RequestorName >
          <MonitoredIndividual>John Doe, Sr.</ Monitoredlndividual >
          <MonitoredIndividualAcct>0104009847</MonitoredIndividualAcct>
          <OtherInterestedParty>Jane Doe</ OtherInterestedParty >
          <RequestorPrimaryEmail>JohnDoe@Fidelity.com</ RequestorPrimaryEmail >
          <InterestedPartyPhone>555-121-3434</ InterestedPartyPhone>
    </enrollment_data>
</enrollment_request_message>
```

Returning to the process, the DAD Server 3101 next processes the enrollment request (Step 306). The initial enrollment of the Subject may be stored by Database Server 104 (step 308). The DAD Server 3101 then retrieves the contact information for the individual to be monitored (step 310). The DAD server 3101 then generates a message for the individual to be monitored (step 312). The message is then transmitted to the Subject via Network Interface Server 106 (step 314). The Subject then logs into the user terminal 108 to receive the message and confirm enrollment (step (316). The enrollment confirmation is received from the User Terminal 108 by Network Server 106 and forwarded to the DAD Server 3101 (step 318). The DAD Server 3101 then commences monitoring the Subject's subsequent financial transactions (step 320) in order to identify possible fraud. The enrollment of the individual to be monitored is stored by Database Server 104 (step 322).

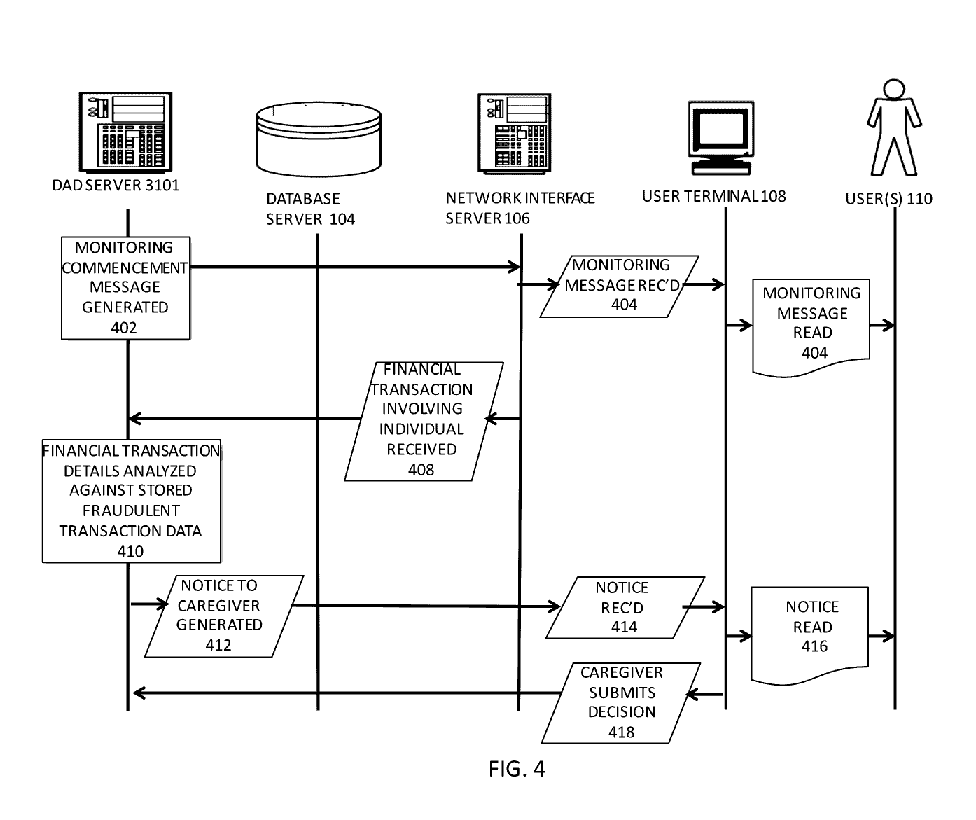

Continuing now to FIG. 4, the process continues to step 402 wherein the DAD Server 3101 generates a monitoring commencement message. The commencement message is received by Network Interface Server 106 and forwarded to the Observer (step 406). The Observer may receive and review the monitoring commencement message via User Terminal 108 (step 406).

Thereafter, the Network Interface Server 106 may receive an indication of a Subject's new financial transaction (step 408), as may be received from Financial Institution Server 112.

An example financial transaction indication message used in step 408, substantially in the form of a HTTP(S) POST message including XML-formatted data, is provided below:

```
POST /authrequest.php HTTP/1.1
Host: www.server.com
Content-Type: Application/XML
Content-Length: 667
<?XML version = “1.0” encoding = “UTF-8”?>
<financial_transaction_indication_message>
    <timestamp>2020-12-31 23:59:59</timestamp>
    <user_accounts_details>
          <user_account_credentials>
                <user_name>JohnDaDoeDoeDoooe@gmail.com</account_name>
                <password>abc123</password>
                //OPTIONAL <cookie>cookieID</cookie>
                //OPTIONAL <digital_cert_link>www.mydigitalcertificate.com/
JohnDoeDaDoeDoe@gmail.com/mycertifcate.dc</digital_cert_link>
                //OPTIONAL <digital_certificate>_DATA_</digital_certificate>
          </user_account_credentials>
    </user_accounts_details>
    <client_details> //iOS Client with App and Webkit
          <client_IP>10.0.0.123</client_IP>
          <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
          <client_product_type>iPhone6,1</client_product_type>
          <client_serial_number>DNXXX1X1XXXX</client_serial_number>
          <client_UDID>3XXXXXXXXXXXXXXXXXXXXXXXXD</client_UDID>
          <client_OS>iOS</client_OS>
          <client_OS_version>7.1.1</client_OS_version>
          <client_app_type>app with webkit</client_app_type>
          <app_installed_flag>true</app_installed_flag>
          <app_name>_Innovation_Nickname_.app</app_name>
          <app_version>1.0 </app_version>
          <app_webkit_name>Mobile Safari</client_webkit_name>
          <client_version>537.51.2</client_version>
    </client_details>
    <client_details> //iOS Client with Webbrowser
          <client_IP>10.0.0.123</client_IP>
          <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
          <client_product_type>iPhone6,1</client_product_type>
          <client_serial_number>DNXXX1X1XXXX</client_serial_number>
          <client_UDID>3XXXXXXXXXXXXXXXXXXXXXXXXD</client_UDID>
          <client_OS>iOS</client_OS>
          <client_OS_version>7.1.1</client_OS_version>
          <client_app_type>web browser</client_app_type>
          <client_name>Mobile Safari</client_name>
          <client_version>9537.53</client_version>
    </client_details>
    <client_details> //Android Client with Webbrowser
          <client_IP>10.0.0.123</client_IP>
          <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
          <client_product_type>Nexus S</client_product_type>
          <client_serial_number>YXXXXXXXXZ</client_serial_number>
          <client_UDID>FXXXXXXXXX-XXXX-XXXX-XXXX-XXXXXXXXXXXXX</client_UDID>
          <client_OS>Android</client_OS>
          <client_OS_version>4.0.4</client_OS_version>
          <client_app_type>web browser</client_app_type>
          <client_name>Mobile Safari</client_name>
          <client_version>534.30</client_version>
    </client_details>
    <client_details> //Mac Desktop with Webbrowser
          <client_IP>10.0.0.123</client_IP>
          <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
          <client_product_type>MacPro5,1</client_product_type>
          <client_serial_number>YXXXXXXXXZ</client_serial_number>
          <client_UDID>FXXXXXXXXX-XXXX-XXXX-XXXX-XXXXXXXXXXXXX</client_UDID>
          <client_OS>Mac OS X</client_OS>
          <client_OS_version>10.9.3</client_OS_version>
          <client_app_type>web browser</client_app_type>
          <client_name>Mobile Safari</client_name>
          <client_version>537.75.14</client_version>
    </client_details>
    <monitored_financial_transaction_data>
          <activityType>mobile</activityType>
          <MonitoredIndividual>John Doe, Sr.</ MonitoredIndividual >
          <MonitoredIndividualAcct>0104009847</MonitoredIndividualAcct>
          <Transaction_Amount>$450.00</Transaction_Amount>
          <TransactionLocation>FidelityBranch001</ TransactionLocation >
          <TransactionDetails>Accompanied By Suspicious Individual</
TransactionDetails >
    </ monitored_financial_transaction_data >
</ financial_transaction_indication_message >
```

Continuing with the process, the DAD Server 3101 next receives the new financial transaction or behavioral data and analyzes it against stored historical fraudulent transaction data or behavioral (step 410). If the comparison indicates one of the possible levels of aberrant behavior, a notification is generated by the DAD Server 3101 and transmitted to the caregiver via the Network Interface Server 106 (step 412). The notice is received, for example, by the Observer via user terminal 108 (step 414) and the details of the notice may be reviewed by the Observer (step 416). The Observer may then submit instructions regarding the transaction (step 418), such as to allow the transaction or deny it. Thereafter, the DAD Server 3101 may transmit an acceptance or disapproval of the financial transaction to the financial institution server 112 from which the new financial transaction data originated. The DAD Server 3101 may take further steps such as storing the decision received from the Observer, notifying the Subject of the approved or denied transaction and the reasons for such action. The process depicted in FIGS. 2-4 then ends.

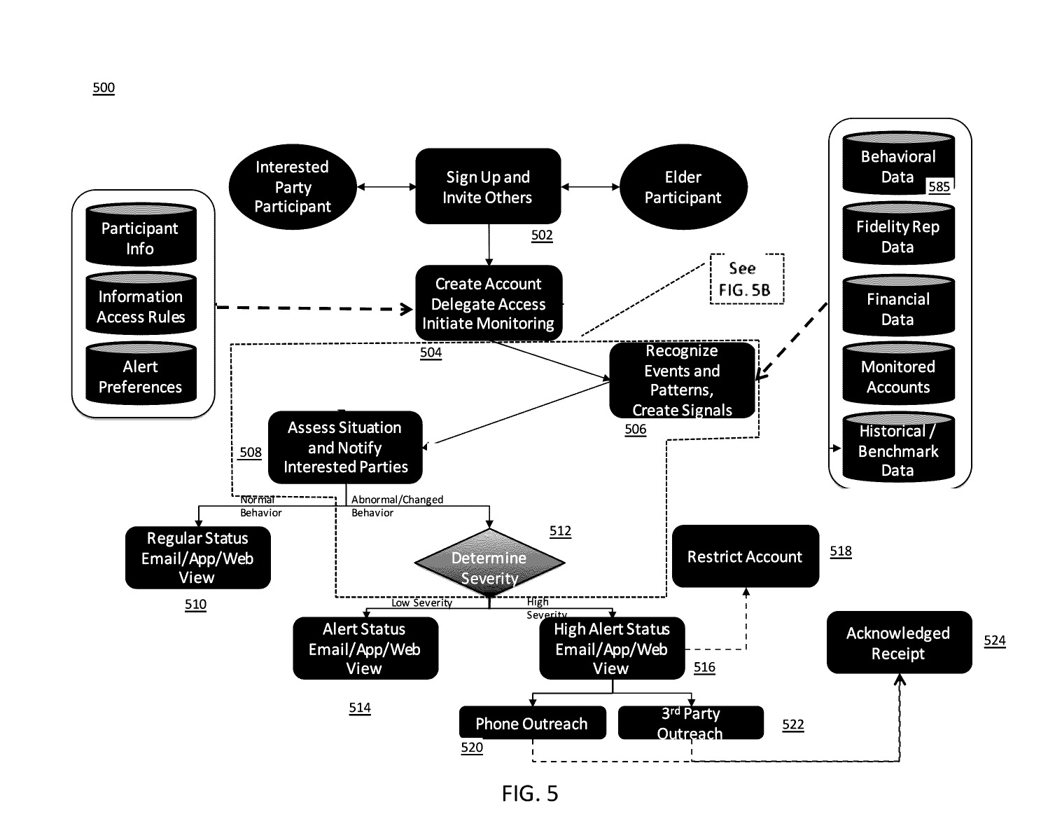

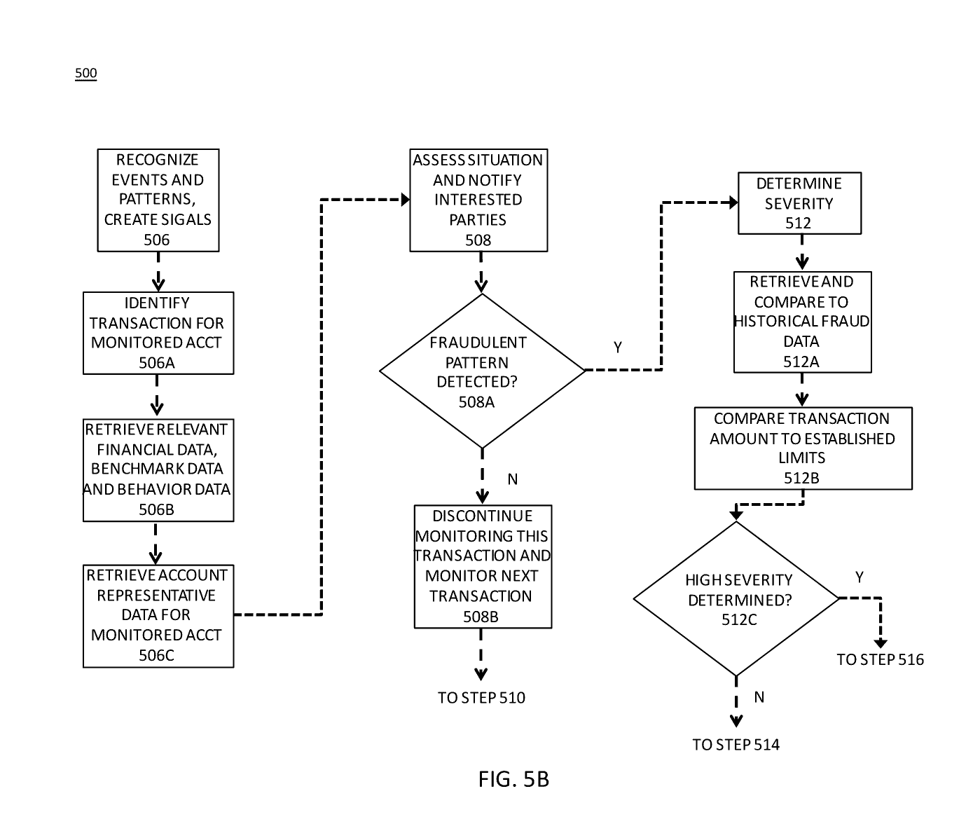

FIG. 5 shows a logic flow diagram illustrating embodiments of a monitoring and alerting process 500 performed via the DAD;

Caregivers, interested parties, elder or impaired customers may sign up and invite other Observers to participate in the DAD System (step 502). The Observer or Subject creates a DAD account, delegates access to the Subject's financial and behavioral information, initiates monitoring of the Subject (step 504) using Observer/Subject information, information access rules, and alert preferences. Thereafter, the DAD System recognizes trigger events and patterns, and creates messages and alert in response thereto when appropriate (step 506) using behavioral data, financial institution stored data monitored account data and historical/benchmark data. Behavioral data for a Subject may be evaluated from behavioral data sources 585, such as recent real-world personal behaviors as may be observed and recorded by physicians, caregivers, law enforcement, friends and the like. For example, wearable technologies may report behaviors to wearable and/or medical databases, which may be further monitored and/or commented on by healthcare professionals. Likewise, behavioral data may come from observations of recent online behavior such as activities on any publicly accessible web sites or social media sites. Aberrant behavioral behaviors of these and related contemplated types noted in advance may trigger an alert regarding a later-occurring financial transactions based on a plurality of algorithmically-determined factors that are observed from the population at large. In this manner, the identification of fraudulent or aberrant transactions may be augmented from those of prior existing systems. The DAD System assesses new financial transactions involving the Subject, and then notifies Observers or other third parties as designated and necessary (step 508). If normal behaviors are determined with respect to a given financial transaction of the Subject, than the DAD system may not generate any alert messages and instead sends a regular status notice listing the cleared transaction via email, application-based messaging, or webpage message generation and delivery (step 510).

If aberrant or abnormal behavior is instead indicated then a severity of the situation is initially assessed (step 512). If low severity, an alert status may be dispatched to the Observer via email, mobile application, or web interface (step 514). If instead a high severity is determined, a high alert status is sent via email/mobile application/web (step 516) and a restriction on the financial transaction is implemented (step 518). In the case of high alerts, there may additional be phone outreach by an DAD representative to the Observer and/or Subject (step 520). There may be additional outreach to other third parties (step 522), such as police or representative of other financial institutions while the transaction is occurring. The notified parties then acknowledge receipt of the high alert status (step 524).

Referring to FIG. 5B, therein is depicted exemplary sub-process steps performed by the DAD System with respect to steps 506, 508 and 512 described in the foregoing. Returning to step 506, as part of a sub-processes for recognizing abnormal events and patterns and creating corresponding signal alerts, the process first continues to step 506 where a transaction for a monitored account is identified.

The transaction may involve any type of financial activity from any of a variety of accounts held at various financial institutions. This financial data may be determined from the data previously received from financial transaction servers 112 (see step 408 above). Responsive thereto, the DAD system retrieves relevant financial and behavioral data from the Financial Database 3151, historical fraud or aberrant activity benchmark data from the Fraud Database 3152 and customer behavior data for the monitored individual from Subject Database 3153 (step 506B). The DAD System further retrieves account representative identification and contact information for the monitored account from the Admin Database 3156 (step 506C). The process then continues to step 508.

As part of a sub-processes for assessing the situation and notifying interested parties at step 508, the DAD System reviews the data retrieved in steps 506A and 506B to detect fraudulent activity patterns with respect to the monitored transaction (step 508A). If a fraudulent pattern is detected, the process continues to step 512, outlined in more detail below. Otherwise, the process continues to step 508B where the transaction ceases to be monitored and the DAD System continues to a next monitored transaction, after which the sub-process continues to step 510 as previously described.

Continuing from step 508A above, when a fraudulent pattern is instead detected with respect to the monitored transaction, the process continues to step 512 where a severity of the fraudulent transaction is determined. As part of a sub-processes for determining the severity, the DAD System first retrieves additional historical financial and/or behavioral data corresponding more specifically to the monitored transaction from the Fraud Database 3151 or behavioral data sources 585 (step 512A). The DAD System next compares the transaction data to limits that were established for the monitored individual (step 512B). The DAD System then compares this data to programmed rules for determining the severity of a fraudulent transaction. If a high severity is determined at step 512C, the sub-process continues to step 516, described previously above. Otherwise, the sub-process continues to step 514, described previously above.

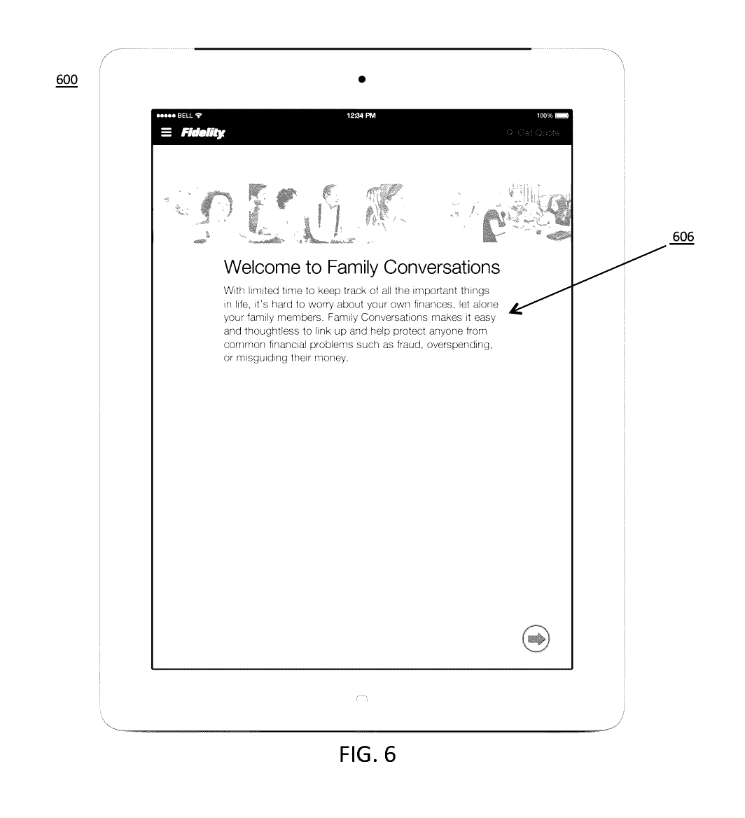

FIGS. 6-30 show screenshot diagrams illustrating exemplary screen displays presented by the DAD.

FIG. 6 shows an exemplary user device 600 which may be used to connect to the DAD System. With the screen display of the user device 600, there is displayed an example of an introductory screen display 606 that may be presented to a user, such as an Observer or Subject, who logs into the DAD System.

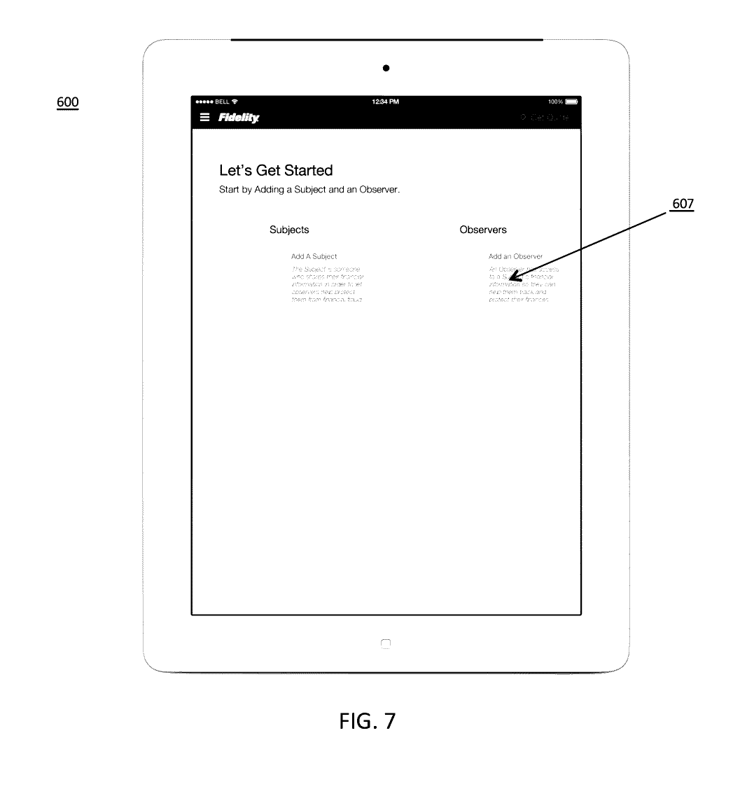

FIG. 7 shows an example of an initial enrollment screen 607 as may be presented to an enrollee on user device 600 during enrollment. In the example shown, the enrollee may start the enrollment process as a “Subject” (i.e., an individual to be monitored) or as an “Observer” (i.e., a caregiver or other trusted party).

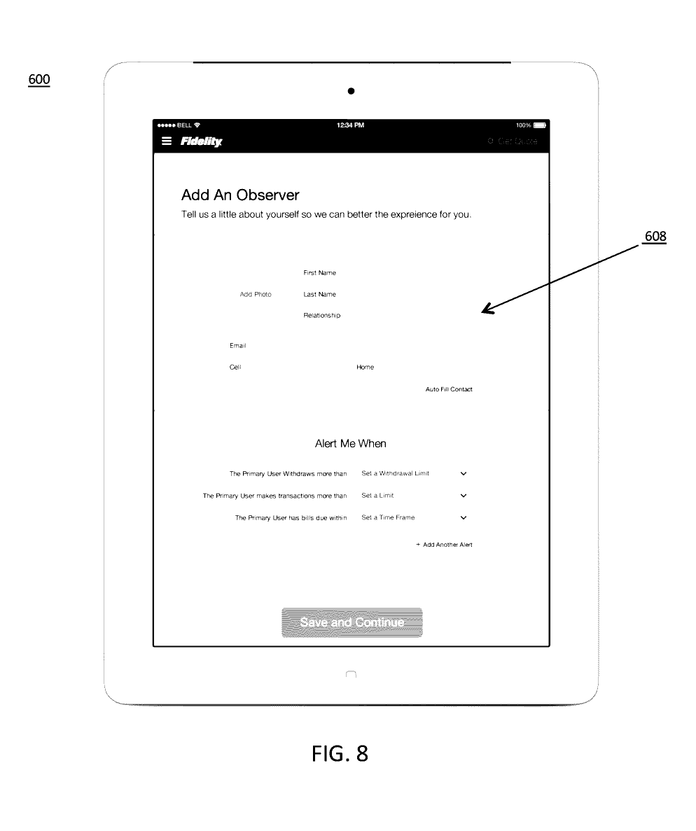

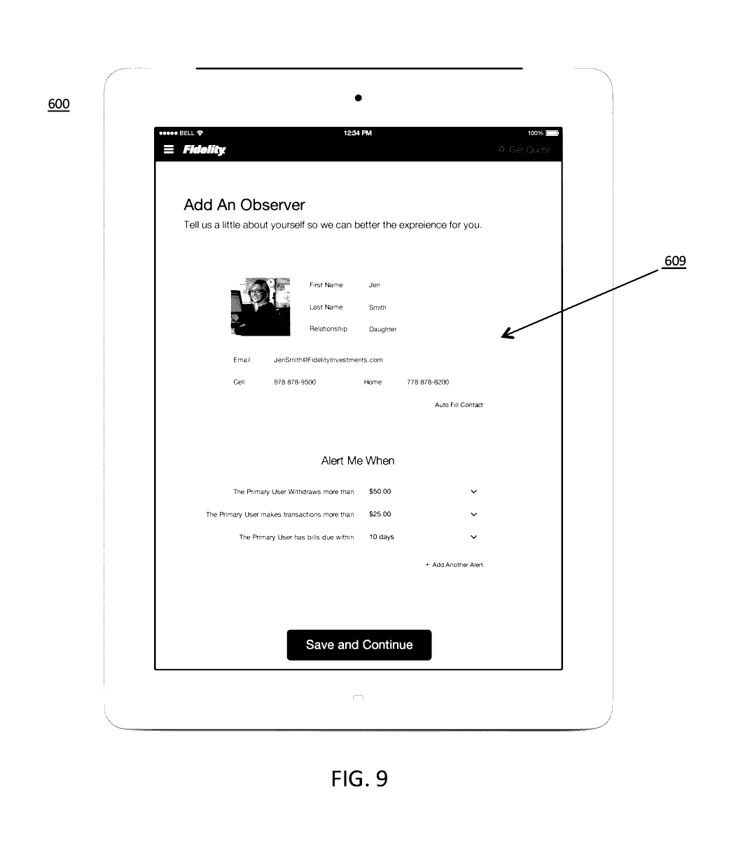

FIG. 8 shows an example of an initial observer enrollment screen 608 as may be presented to an enrollee on user device 600. The initial observer enrollment screen 608 may include one or more fields for data input by the user/observer. These fields include first name, last name, relationship to the individual to be monitored, contact e-mail address, contact mobile telephone number and/or contact home or work telephone number. The user/observer may also select alert preferences and triggers, such as “Notify me when the Subject withdraws more than X dollars,” “The Subject makes transactions more than Y times per day,” and/or “The Subject has bills due within Z days or past due.” The variables X, Y and Z may be set by the Observer as desired. FIG. 9 shows an example of a completed initial observer enrollment screen 609 where such variables have been selected by the enrollee as an Observer.

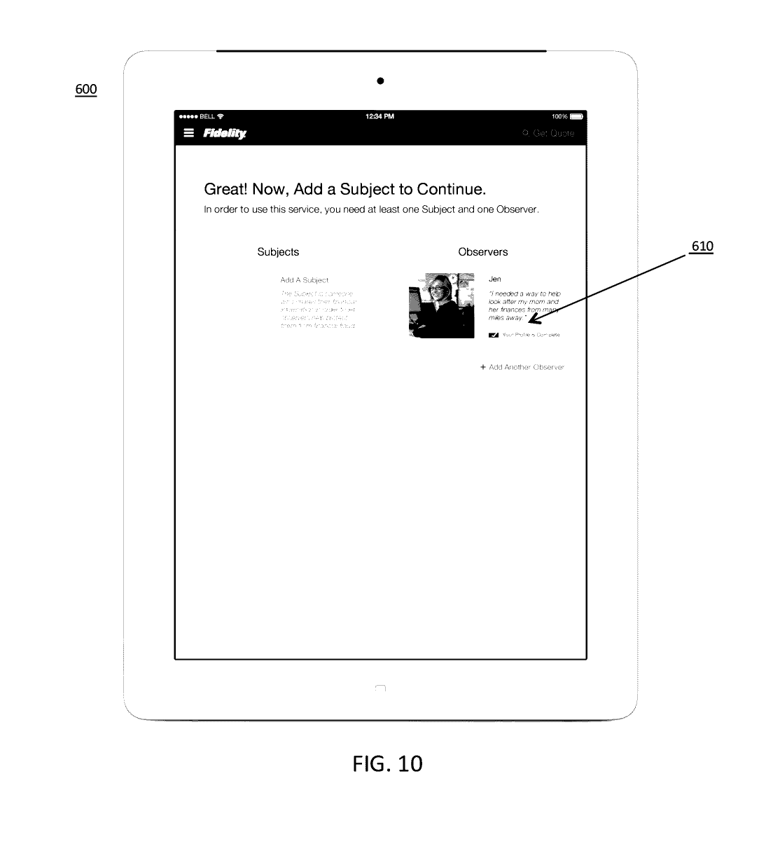

FIG. 10 shows an example of an observer enrollment confirmation screen 610 as may be presented to an Observer on user device 600. As shown therein, the Observer's information and an uploaded photograph are now displayed in the observer section of the screen 610. The user may then select the “Subjects” section to enroll a Subject.

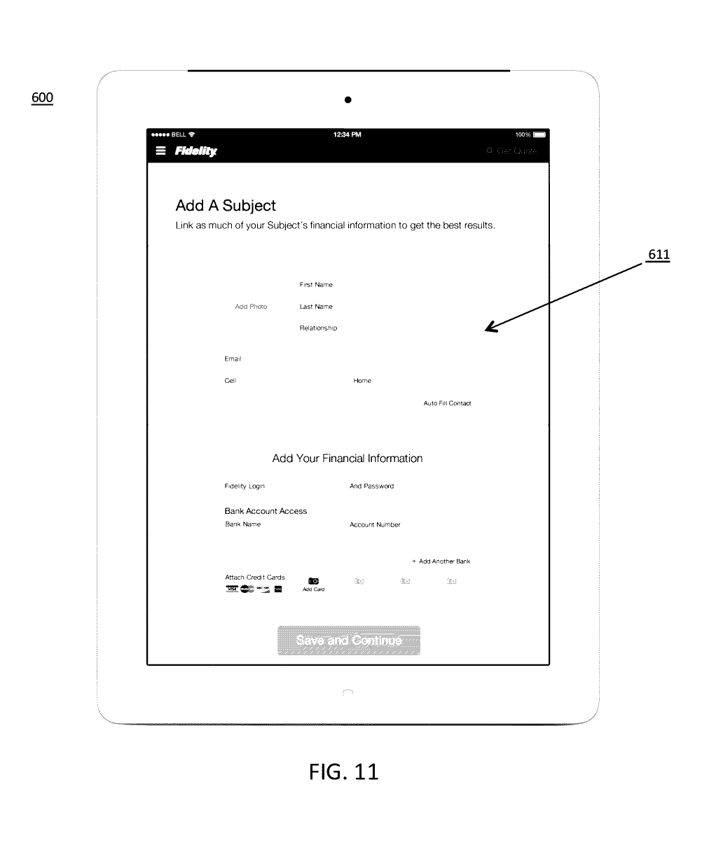

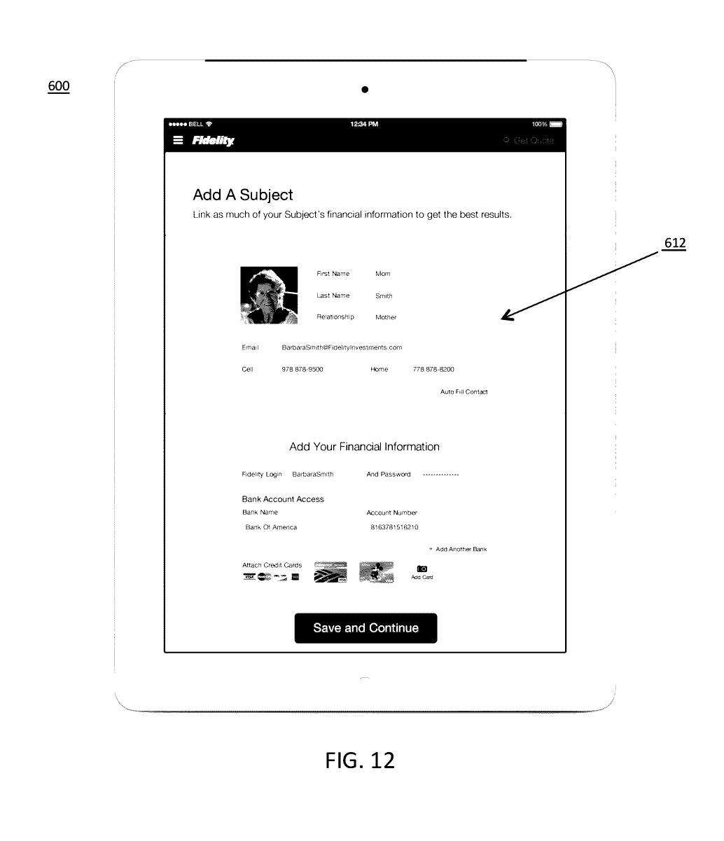

FIG. 11 shows an example of an initial subject enrollment screen 611, as may be presented to an Observer on user device 600. The initial subject enrollment screen 611 may include one or more fields for data input by the user/observer. These fields include first name, last name, relationship to the Subject, contact e-mail address, contact mobile telephone number and/or contact home telephone number. The fields may also include those related to an existing financial account or accounts of the Subject, which may be with a financial institution that operates the DAD system, or with any other participating institution. Such additional fields may include, in particular, an existing account login ID, a password for the existing account, the name of the financial institution holding the account, the account number, bank routing number and the like. One or more additional accounts from any number of financial institutions may be added as well. If the individual has no initial accounts, accounts may be created and then entered via screen 611. Alert settings, as described with respect to FIG. 8, may likewise be entered here in accordance with the preferences of the Subject. FIG. 12 shows an example of a completed initial subject enrollment screen 612 where required information for the fields has been entered by the Observer/enrollee.

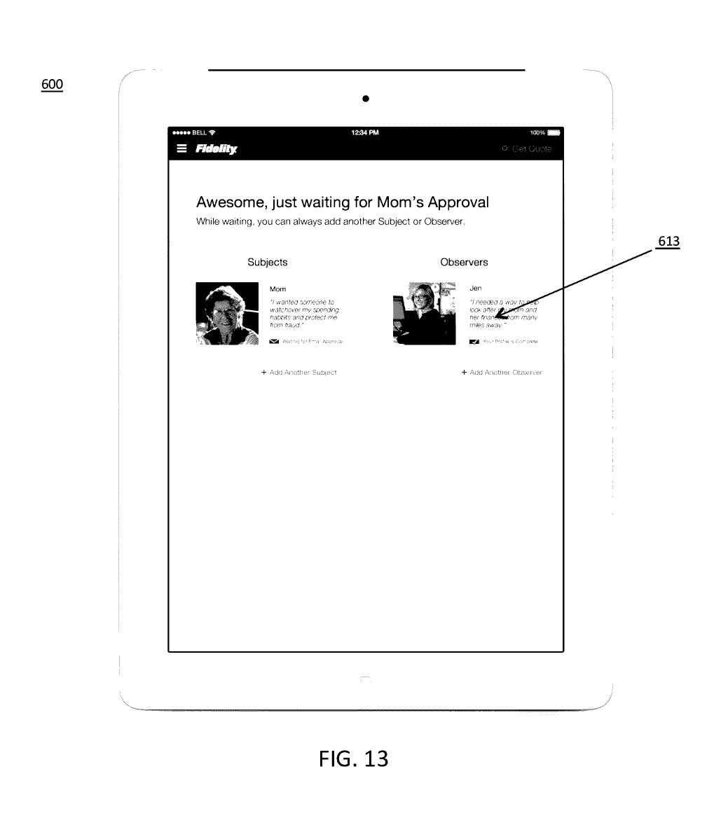

FIG. 13 shows an example of a notification pending screen 613, as may be presented to an Observer on user device 600. The notification pending screen 613 contains messages to the Observer that approval of enrollment by the subject has been sent and is pending a response by the Subject.

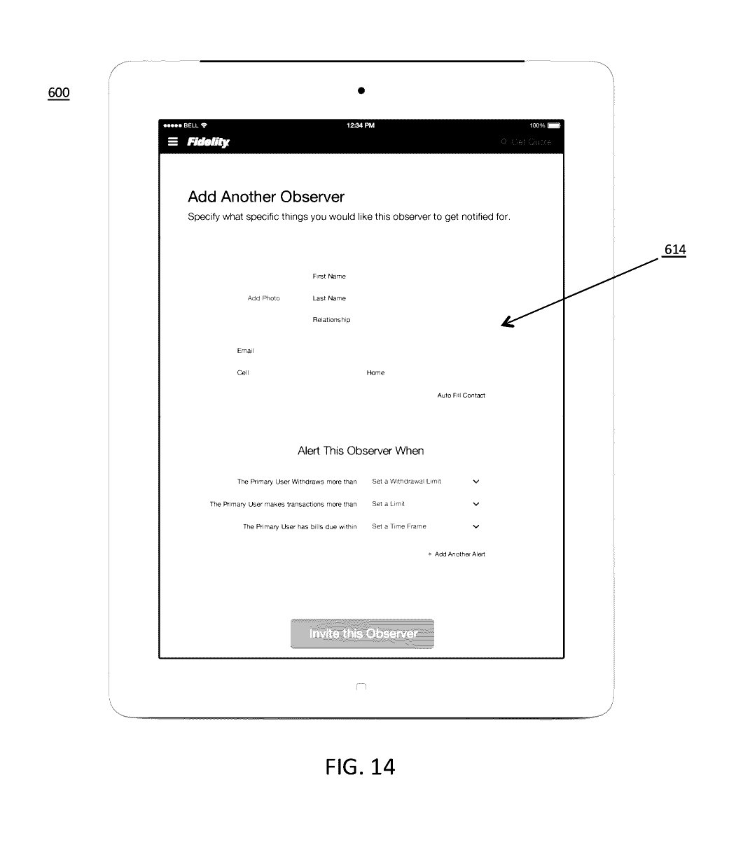

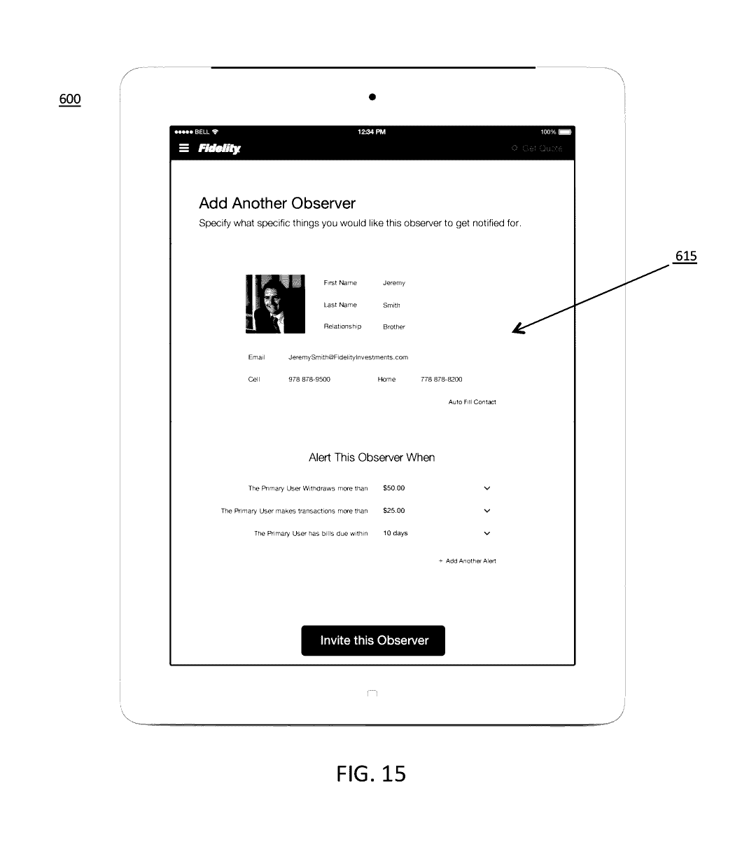

FIG. 14 shows an example of a second observer enrollment screen 614, as may be presented to an Observer on user device 600. Here, the Observer may add a second Observer via the fields of this screen 614. Such fields may reflect the fields described with respect to the initial observer enrollment screen 608 of FIG. 8. FIG. 15 shows an example of a completed second observer enrollment screen 615 where such fields and variables have been input by the Observer.

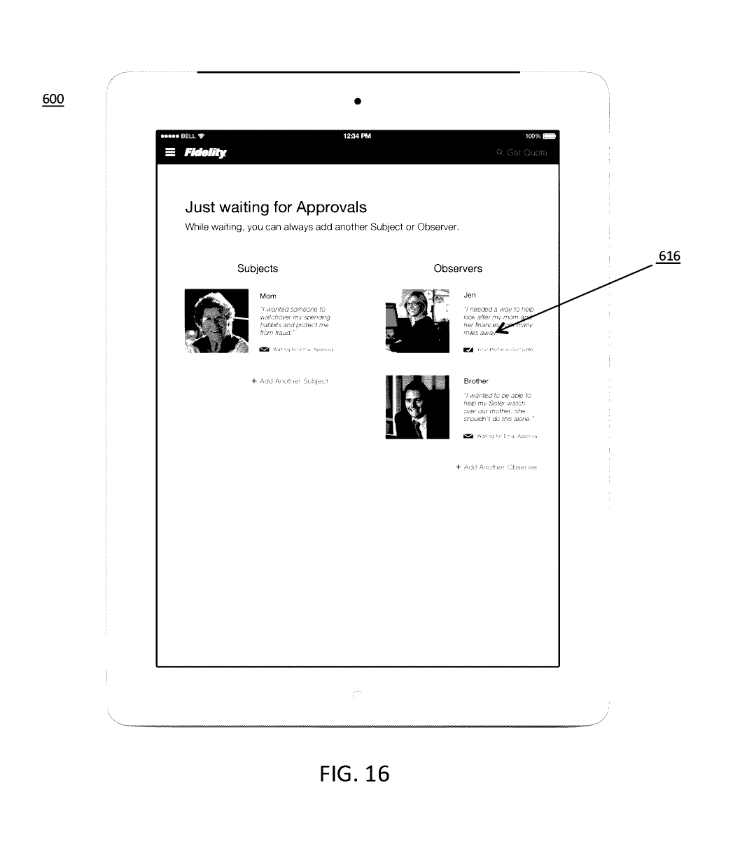

FIG. 16 shows an example of a second notification pending screen 616, as may be presented to an Observer on user device 600. The second notification pending screen 616 contains messages to the Observer that approval of enrollment by the added Observer has been sent and is pending a response by the added Observer.

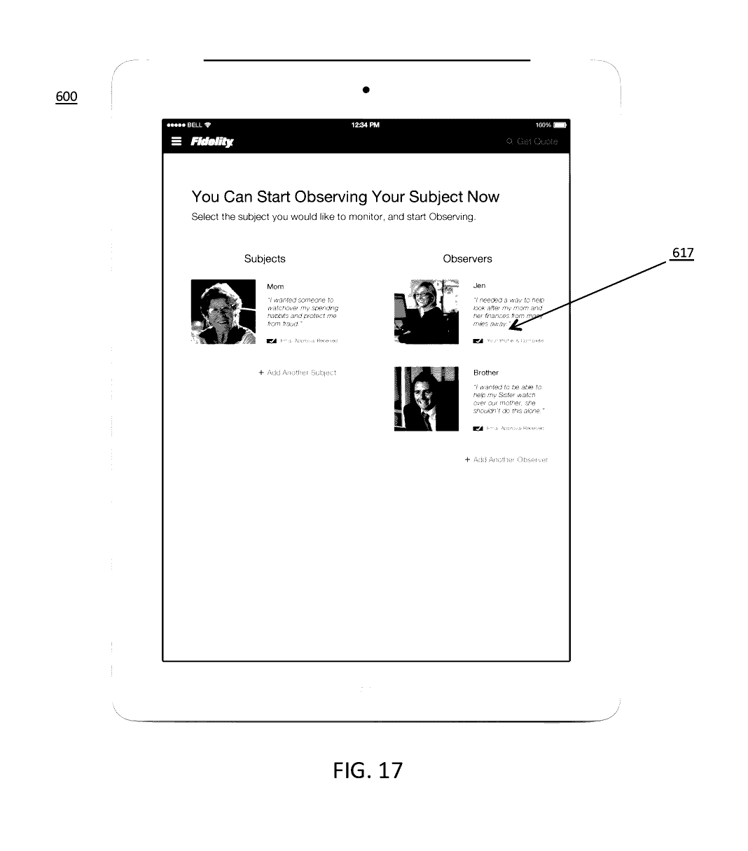

FIG. 17 shows an example of an enrollment approval screen 617, as may be presented to an Observer on user device 600. The screen 617 my include messages confirming the received approval of enrollment from the Subject and the added Observer. Various additional Observers may likewise be added in the manner presented in the foregoing.

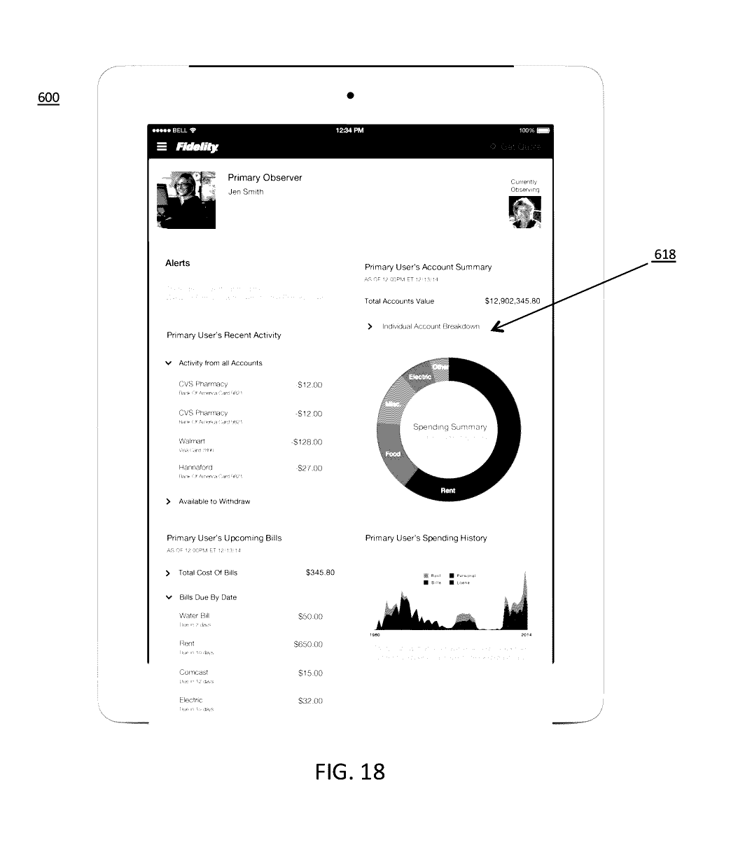

FIG. 18 shows an example of a first primary observer screen 618, as may be presented to an Observer on user device 600. The screen 618 may present alerts, recent financial activity of the Subject, upcoming bills that are due for the Subject, financial account summaries (e.g., individual account balances) for the Subject, a graph or chart of the spending summary (i.e., percentage of money spent on various spending categories like utilities, food, transportation, housing and the like) of the Subject, and a graph or chart of the spending history of the Subject (e.g., spending totals by month over any number of previous months). In this screen 618, the Observer has selected a dropdown menu for Activity From All Accounts under the “Recent Activity” pane presented there within, and a number of recent transactions from all accounts of the Subject are displayed.

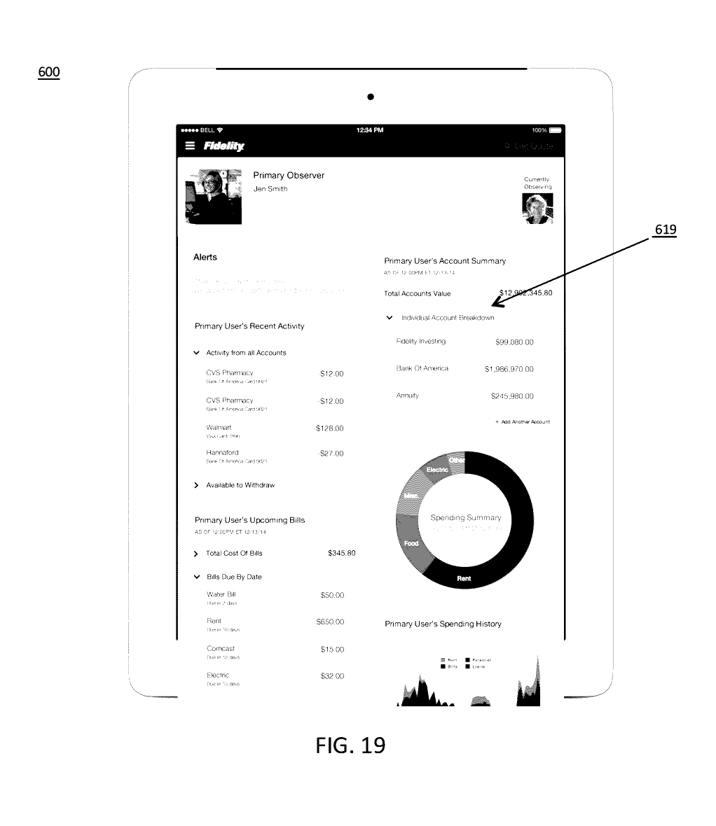

FIG. 19 shows an example of a second primary observer screen 619, as may be presented to an Observer on user device 600. In this screen 619, the Observer has selected a dropdown menu for Individual Account Breakdown under the “Account Summary” pane presented there within, and individual account balances for a number of individual accounts of the Subject are displayed.

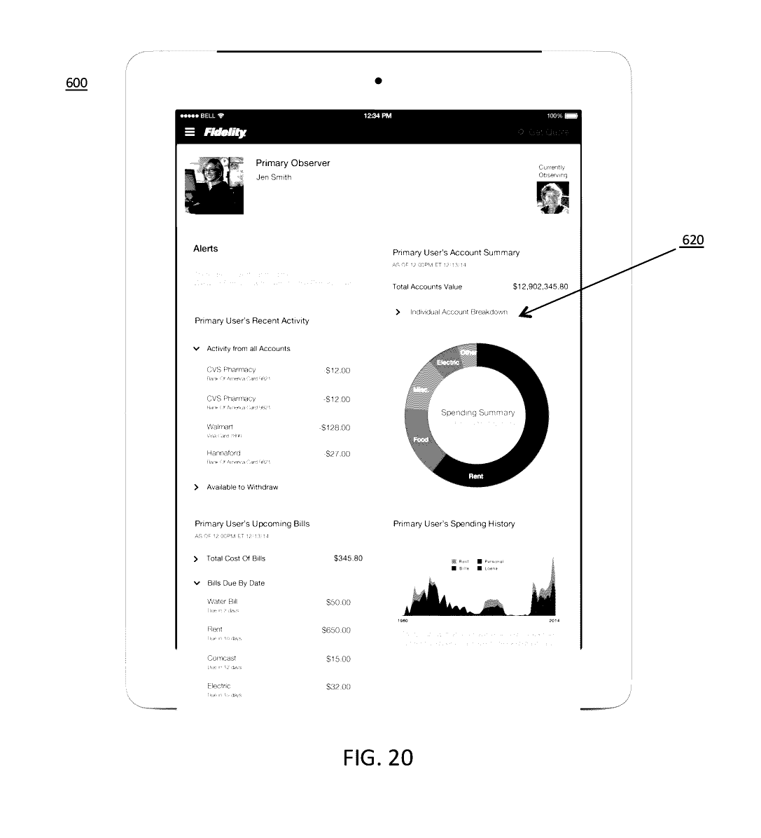

FIG. 20 shows an example of a third primary observer screen 620, as may be presented to an Observer on user device 600. In this screen 620, the Observer has selected a dropdown menu under the “Upcoming Bills” pane presented there within, and specific information for a number of upcoming bills of the Subject are displayed (e.g., utility bills, rent, mortgage payments and the like).

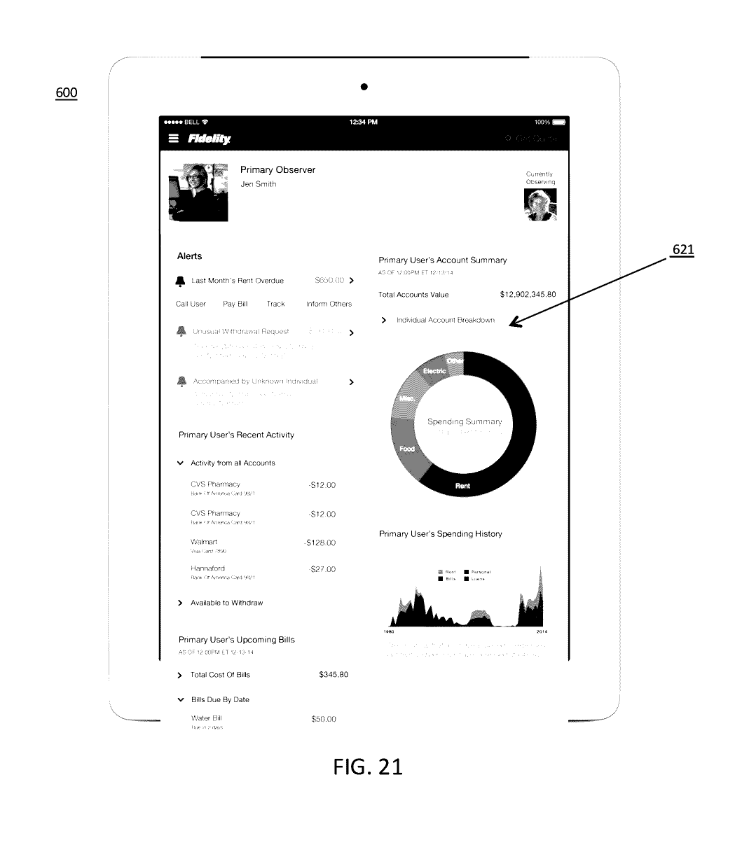

FIG. 21 shows an example of a fourth primary observer screen 621, as may be presented to an Observer on user device 600. In this screen 621, a number of prior and/or current alerts may be presented in the alert pane displayed there within. Alerts may include a notice of an overdue bill, a notice of an unusual withdraw request, a report of an unknown individual accompanying the Subject during a financial transaction. Dollar amounts involved in any individual alert may also be provided. Various other types of alerts are provided herein. Other types of well-known existing alerts will be readily contemplated as well by one of ordinary skill in the art.

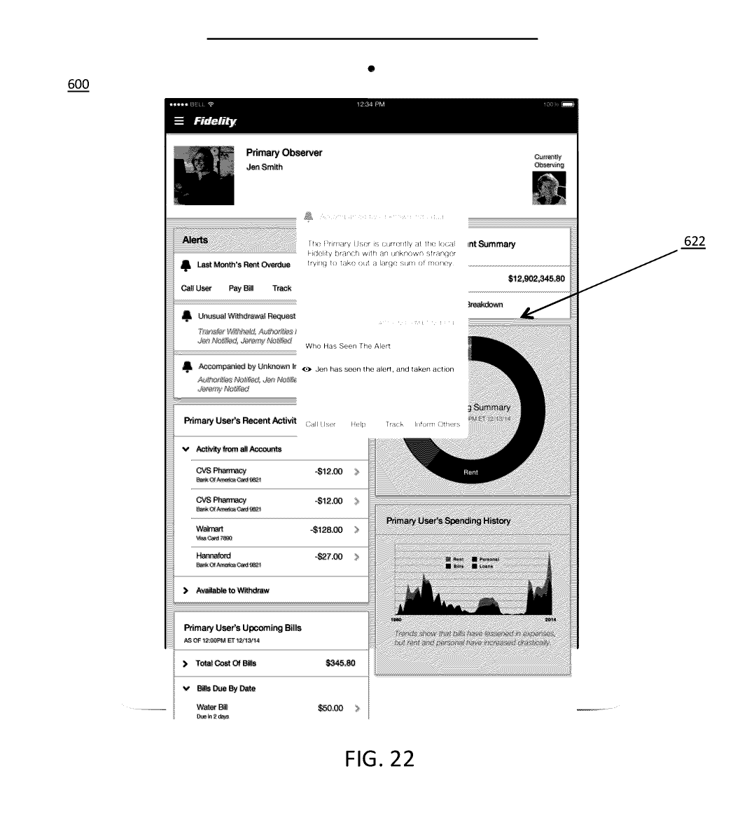

FIG. 22 shows an example of a first pop-up alert screen 621, as may be presented to a user on user device 600. The screen 622 may present a new alert related to a new financial transaction initiated by the Subject being monitored. The screen 622 may include a message detailing a suspected fraudulent transaction, for example, that the subject being monitored is attempting a large cash withdrawal while accompanied by a stranger. In such example, the screen 622 may further include an indication that authorities have been notified. The screen 622 may further indicate which Observers have seen this alert, whether action has been taken by any Observer in response to this alert. The screen 622 may further include selectable options for taking an action in response to the alert, such as contacting the Subject, contacting others, and options to cause the transaction to be denied.

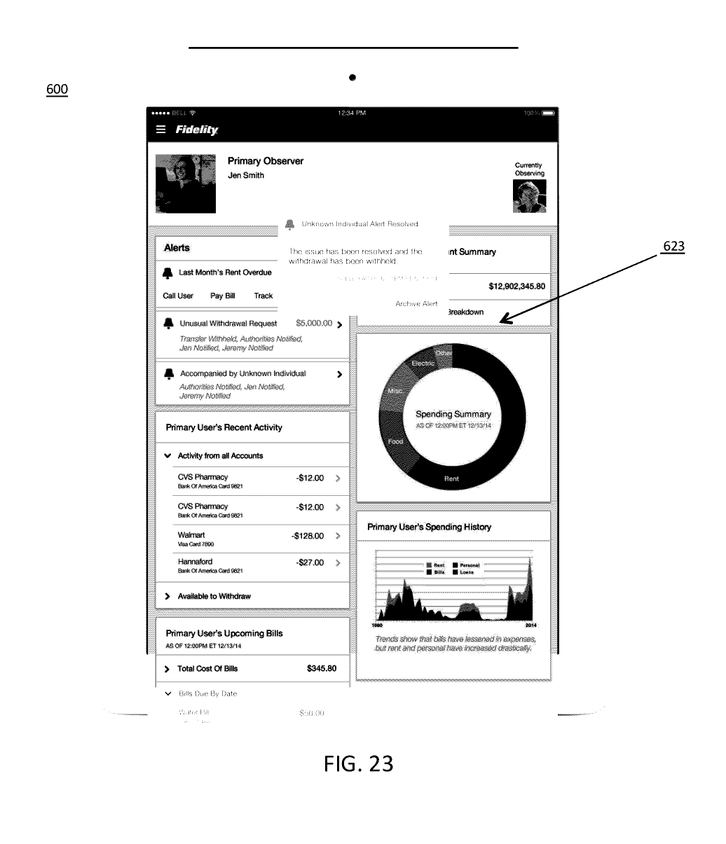

FIG. 23 shows an example of a pop-up resolution screen 623, as may be presented to an Observer on user device 600. The screen 623 may present information about the successful resolution of an attempted fraudulent transaction. The screen 623 may further present an option to archive the resolved alert.

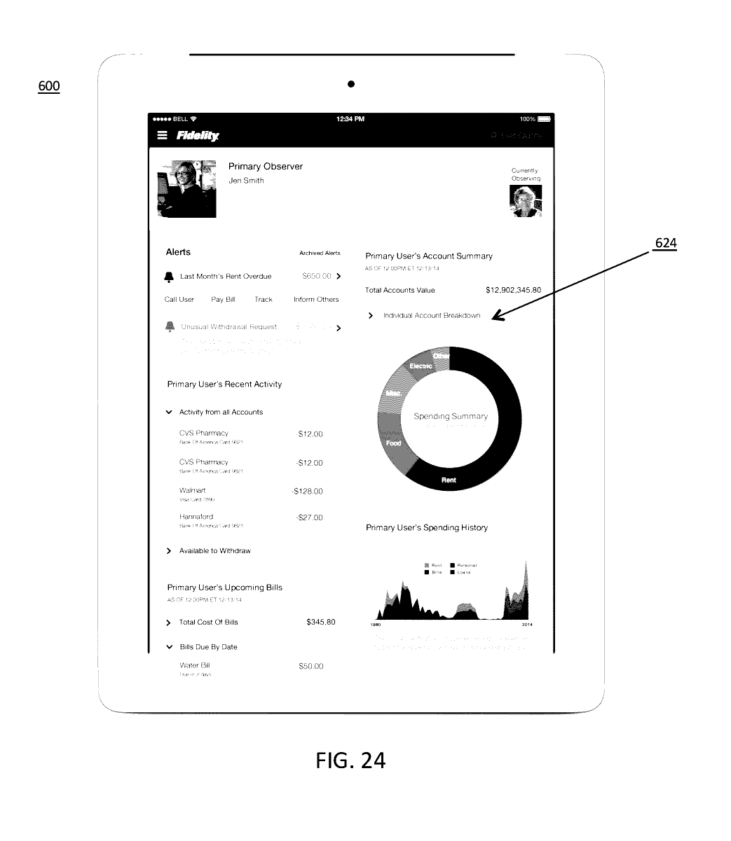

FIG. 24 shows an example of an archived alert screen 624, as may be presented to an Observer on user device 600. After a resolved alert has been archived, the Alerts pane may reflect the archived status, such as by presenting the archived alert in a separate color than an active alert.

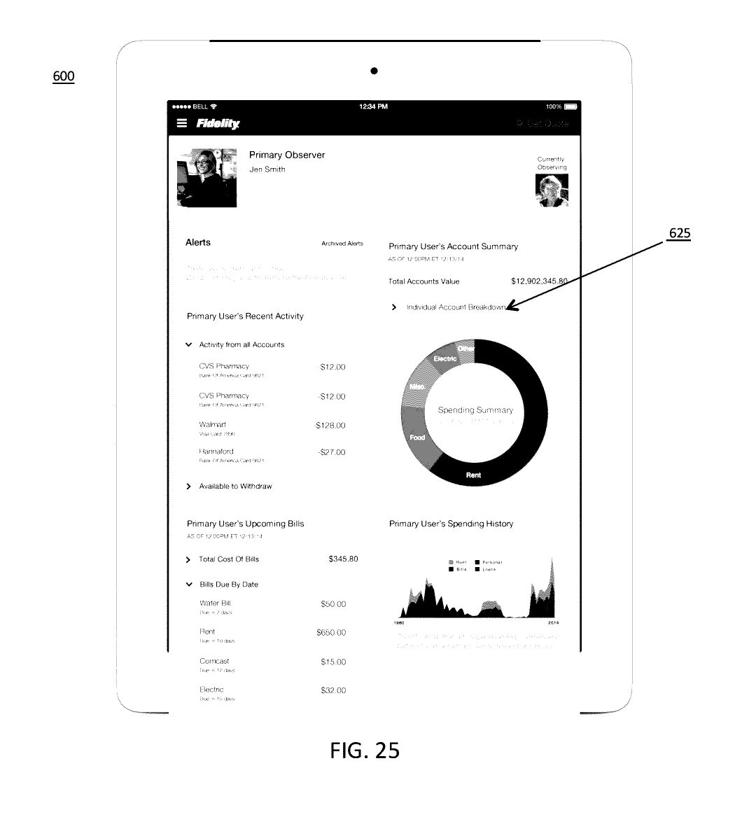

FIG. 25 shows an example of a fifth primary observer screen 625, as may be presented to an Observer on user device 600. After a resolved alert has been archived, it may be removed from the Alerts pane of the screen 625, for example, after an established time.

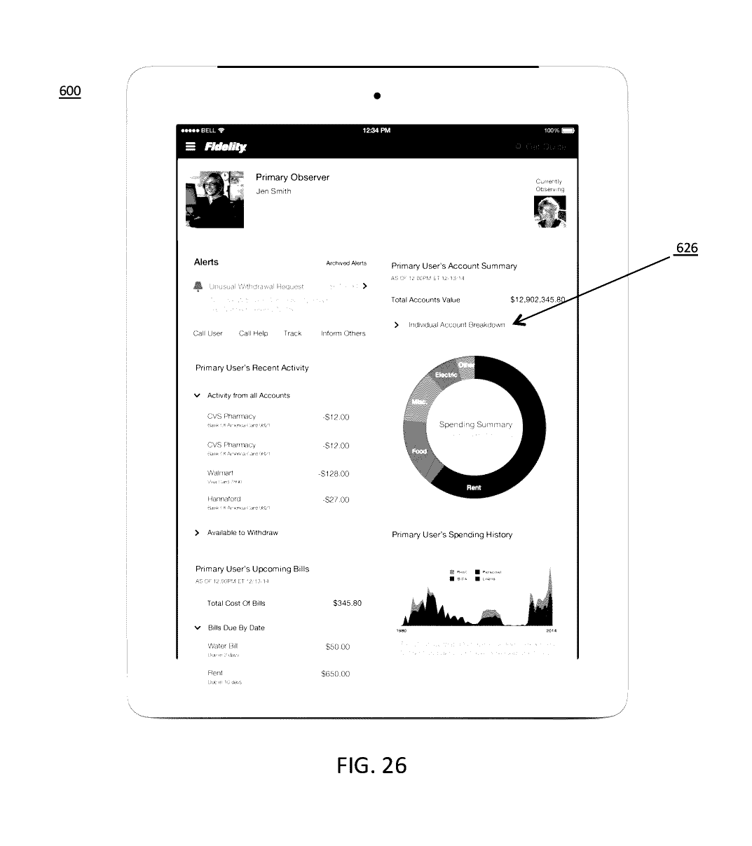

FIG. 26 shows an example of a sixth primary observer screen 626, as may be presented to an Observer on user device 600. The screen 626 may show a second alert in the Alerts pane. In the example as shown, the new alert may relate to an attempted withdrawal by an unauthorized relative of the Subject.

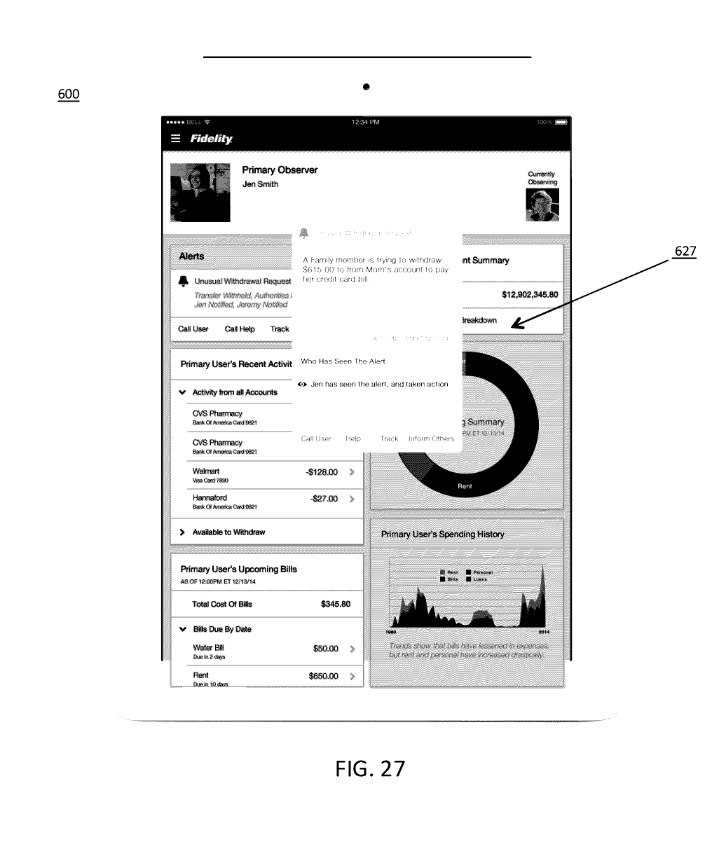

FIG. 27 shows an example of a second pop-up alert screen 627, as may be presented to an Observer on user device 600. The screen 627 may include a message detailing a suspected fraudulent transaction, for example, that an unauthorized relative is attempting to make a large cash withdrawal from the Subject's account. The screen 627 may further indicate which Observers have seen this alert, whether action has been taken by any Observer in response to this alert. The screen 627 may further include selectable options for taking an action in response to the alert, such as contacting the Subject, contacting others, and options to cause the transaction to be approved or denied.

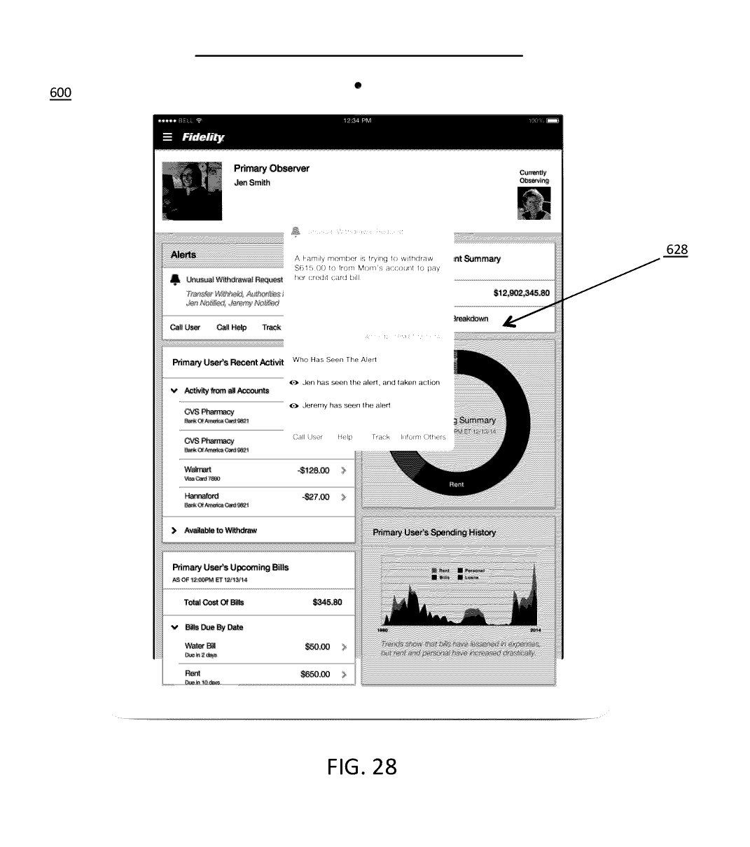

FIG. 28 shows an example of the second pop-up alert screen 628, but in which a further notification is provided than an additional Observer has seen the alert and any actions taken by that additional Observer.

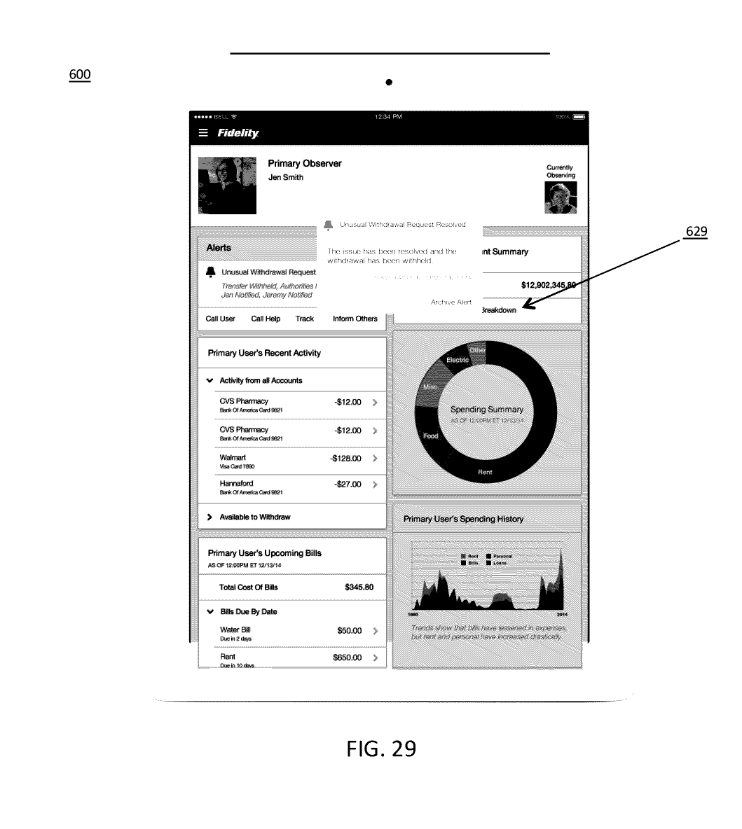

FIG. 29 shows an example of a second pop-up resolution screen 629, as may be presented to an Observer on user device 600. The screen 629 may present information about the successful resolution of an attempted fraudulent transaction. The screen 629 may further present an option to archive the resolved alert.

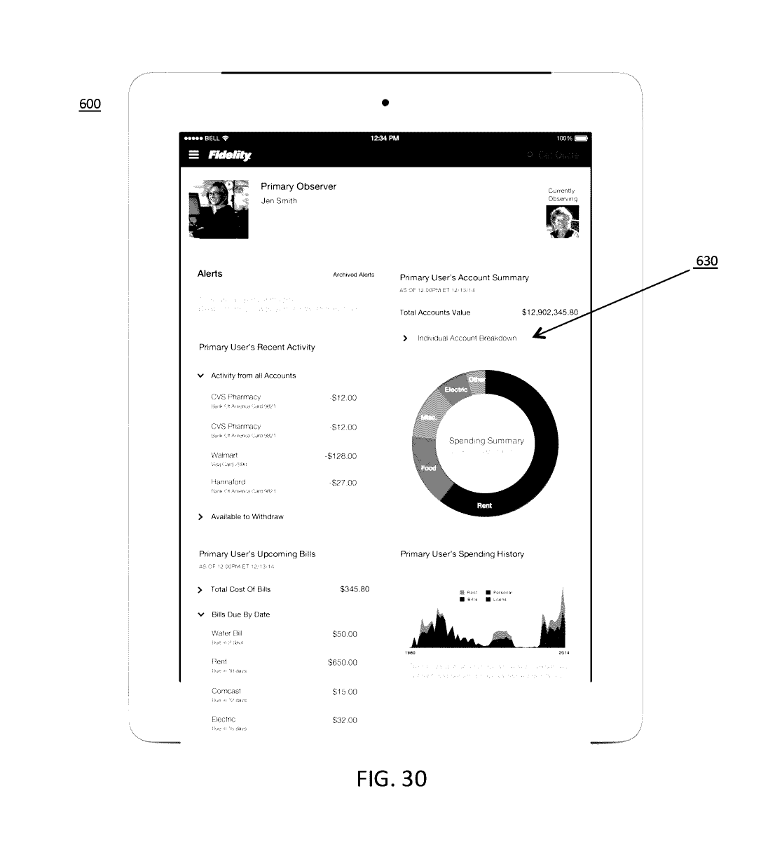

FIG. 30 shows an example of a seventh primary observer screen 630, as may be presented to an Observer on user device 600. After a resolved alert has been archived, it may be removed from the Alerts pane of the screen 630, for example, after an established time.

### Example Datastructure Commands

In one implementation, after receiving the new enrollment request, the DAD server(s) 3101 may parse the message, and retrieve the user record from the one or more databases and/or tables (e.g., customer profile database, financial transaction databases, financial monitoring rules databases, etc.). The DAD server(s) 3101 may then update the user record and store the updated user record to the customer profile database. An exemplary listing, written substantially in the form of PHP/SQL commands, to update the user record in the customer profile database, is provided below:

### Update Record

<?PHP
header(‘Content-Type: text/plain’);
// store input data in a database
mysql_connect(“201.408.185.132”,$DBserver,$password); // access database server
mysql_select(“Customer_Profile_DB.SQL”); // select database to append
mysql_query(“UPDATE UserTable
SET street_name = ‘400 Turtle bay road’, apt_unit = ‘6H’, city = ‘New York’,
zip_code = ‘10086’ timestamp = ‘2013-02-22 15:22:43’
WHERE username = ‘JDoe@gmail.com’”);
mysql_close(“CSF_DB.SQL”); // close connection to database
?>

In some embodiments, the DAD server 3101 may then query a data store for an image of the customer, or the like. An example PHP/SQL listing for querying a database for an image is provided below:

### Query Record

<?PHP
header(‘Content-Type: text/plain’);
mysql_connect(“254.93.179.112”,$DBserver,$password); // access database server
mysql_select_db(“CARDIMAGES.SQL”); // select database table to search //create
query for token arbitrators
$query = “SELECT card_id, file_location, file_format FROM CardTemplate WHERE
card_type LIKE ‘%’ $usercardtype”;
$result = mysql_query($query); // perform the search query
mysql_close(“ARBITRATORS.SQL”); // close database access
?>

The DAD server 3101 may then use any information received from the customer profile database to modify the user's account profile via a MySQL database command similar to the following:

INSERT INTO user_cards (number, security_code, ID, address, expire) VALUES
(card_number, card_security, card_ID, card_address, card_expire);

For example, an example PHP/SQL command listing, illustrating substantive aspects of querying a customer profile database for modification date of default address, is provided below:

<?PHP
header(‘Content-Type: text/plain’);
mysql_connect(“254.93.179.112”,$DBserver,$password); // access database server
mysql_select_db(“FidelityCustomerProfile.SQL”); // select database table to
search
//create query for FidelityCustomerprofile data
$query = “SELECT modification_date FROM FidelityCustomerProfileTable WHERE
customer_ID LIKE ‘%’ $123abc” default_address LIKE ‘%’ $address”;
$result = mysql_query($query); // perform the search query
mysql_close(“FidelityCustomerProfile.SQL”); // close database access
?>

An example PHP/SQL command listing, illustrating substantive aspects of querying the customer profile database for modification date of address is provided below:

<?PHP
header(‘Content-Type: text/plain’);
mysql_connect(“254.93.179.112”,$DBserver,$password); // access database server
mysql_select_db(“FidelityCustomerProfile.SQL”); // select database table to
search
//create query for FidelityCustomerProfile data
$query = “SELECT modification_date FROM FidelityCustomerProfileTable WHERE
customer_ID LIKE ‘%’ $123abc” default_address LIKE ‘%’ $address”;
$result = mysql_query($query); // perform the search query
mysql_close(“FidelityCustomerProfile.SQL”); // close database access
?>

For example, if an address needs to be updated between entities (as discussed below), an example PHP/SQL command listing, illustrating substantive aspects of querying the database, is provided below:

<?PHP
header(‘Content-Type: text/plain’);
mysql_connect(“254.93.179.112”,$DBserver,$password); // access database server
mysql_select_db(“CustomerProfile.SQL”); // select database table to search
//create query for Customerprofile data
$query = “SELECT Address_book FROM CustomerProfileTable WHERE customer_ID LIKE
‘%’ $123abc”;
//other info type may be put here depending on the context
$result = mysql_query($query); // perform the search query
mysql_close(“CustomerProfile.SQL”); // close database access
?>

### DAD Controller

FIG. 31 shows a block diagram illustrating embodiments of an DAD controller 3101. In this embodiment, the DAD controller 3101 may serve to aggregate, process, store, search, serve, identify, instruct, generate, match, and/or facilitate interactions with a computer through Fraud Detection and Prevention technologies, and/or other related data.

Typically, users, which may be people and/or other systems, may engage information technology systems (e.g., computers) to facilitate information processing. In turn, computers employ processors to process information; such processors 3104 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 3108 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU 3104 on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the DAD controller 3101 may be connected to and/or communicate with entities such as, but not limited to: one or more users from user input devices 3124; peripheral devices 3126; an optional cryptographic processor device 3128; and/or a communications network 3130.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The DAD controller 3101 may be based on computer systems that may comprise, but are not limited to, components such as: a computer systemization 3102 connected to memory 3108.

### Computer Systemization

A computer systemization 3102 may comprise a clock 3105, central processing unit (“CPU(s)” and/or “processor(s)” (these terms are used interchangeable throughout the disclosure unless noted to the contrary)) 3104, a memory 3108 (e.g., a read only memory (ROM) 3110, a random access memory (RAM) 3108, etc.), and/or an interface bus 3118, and most frequently, although not necessarily, are all interconnected and/or communicating through a system bus 3106 on one or more (mother)board(s) having conductive and/or otherwise transportive circuit pathways through which instructions (e.g., binary encoded signals) may travel to effectuate communications, operations, storage, etc. The computer systemization 3102 may be connected to a power source 3103; e.g., optionally the power source may be internal. Optionally, a cryptographic processor 3112 may be connected to the system bus. In another embodiment, the cryptographic processor and/or transceivers (e.g., ICs) 3138 may be connected as either internal and/or external peripheral devices 3126 via the interface bus I/O 3116 and/or directly via the interface bus 3118. In turn, the transceivers may be connected to antenna(s) 3136, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+EDR, FM, etc.); a Broadcom BCM4750IUB8 receiver chip (e.g., GPS); a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); an Infineon Technologies X-Gold 618-PMB9800 transceiver chip (e.g., providing 2G/3G HSDPA/HSUPA communications); a MediaTek MT6620 transceiver chip (e.g., providing 802.11a/b/g/n, Bluetooth 4.0 LE, FM, global positioning system (GPS) (thereby allowing DAD controller 3101 to determine its location); a Texas Instruments WiLink WL1283 transceiver chip (e.g., providing 802.11n, Bluetooth 3.0, FM, GPS); and/or the like. The system clock 3105 typically has a crystal oscillator and generates a base signal through the computer systemization's circuit pathways. The clock 3105 is typically coupled to the system bus 3106 and various clock multipliers that will increase or decrease the base operating frequency for other components interconnected in the computer systemization. The clock 3105 and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU 3104, and/or organized in numerous variations employed as exemplified by various computer systems.

The CPU 3104 comprises at least one high-speed data processor adequate to execute program components for executing user and/or system-generated requests. The CPU 3104 is often packaged in a number of formats varying from large mainframe computers, down to mini computers, servers, desktop computers, laptops, netbooks, tablets (e.g., iPads, Android and Windows tablets, etc.), mobile smartphones (e.g., iPhones, Android and Windows phones, etc.), wearable devise (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 3108 beyond the processor itself; internal memory may include, but is not limited to: fast registers, various levels of cache memory (e.g., level 1, 2, 3, etc.), RAM, etc. The processor 3104 may access this memory 3108 through the use of a memory address space that is accessible via instruction address, which the processor 3104 can construct and decode allowing it to access a circuit path to a specific memory address space having a memory state. The CPU 3104 may be a microprocessor such as: AMD's Athlon, Duron and/or Opteron; Apple's A series of processors (e.g., A5, A6, A7, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the DAD controller 3101 and beyond through various interfaces. Should processing requirements dictate a greater amount speed and/or capacity, distributed processors (e.g., Distributed DAD), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the DAD may be achieved by implementing a microcontroller such as CAST's R8051XC2 microcontroller; Intel's MCS 51 (i.e., 8051 microcontroller); and/or the like. Also, to implement certain features of the DAD, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the DAD component collection (distributed or otherwise) and/or features may be implemented via the microprocessor and/or via embedded components; e.g., via ASIC, coprocessor, DSP, FPGA, and/or the like. Alternately, some implementations of the DAD may be implemented with embedded components that are configured and used to achieve a variety of features or signal processing.

Depending on the particular implementation, the embedded components may include software solutions, hardware solutions, and/or some combination of both hardware/software solutions. For example, DAD features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the DAD features. A hierarchy of programmable interconnects allow logic blocks to be interconnected as needed by the DAD system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the DAD may be developed on regular FPGAs and then migrated into a fixed version that more resembles ASIC implementations. Alternate or coordinating implementations may migrate DAD controller features to a final ASIC instead of or in addition to FPGAs. Depending on the implementation all of the aforementioned embedded components and microprocessors may be considered the “CPU” and/or “processor” for the DAD.

### Power Source

The power source 3103 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 3101 is connected to at least one of the interconnected subsequent components of the DAD thereby providing an electric current to all subsequent components. In one example, the power source 3101 is connected to the system bus component 3101. In an alternative embodiment, an outside power source 3186 is provided through a connection across the I/O interface 3116. For example, a USB and/or IEEE 1394 connection carries both data and power across the connection and is therefore a suitable source of power.

### Interface Adapters

Interface bus(ses) 3118 may accept, connect, and/or communicate to a number of interface adapters, conventionally although not necessarily in the form of adapter cards, such as but not limited to: input output interfaces (I/O) 3116, storage interfaces 3122, network interfaces 3120, and/or the like. Optionally, cryptographic processor interfaces 3114 similarly may be connected to the interface bus. The interface bus provides for the communications of interface adapters with one another as well as with other components of the computer systemization 3102. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 3122 may accept, communicate, and/or connect to a number of storage devices such as, but not limited to: storage device 3140, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 3120 may accept, communicate, and/or connect to a communications network 3130. Through a communications network 3130, the DAD controller 3101 is accessible through remote clients 3132 (e.g., computers with web browsers) by users 3134. Network interface 3120 may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., Distributed DAD), architectures may similarly be employed to pool, load balance, and/or otherwise decrease/increase the communicative bandwidth required by the DAD controller 3101. A communications network 3130 may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 3110 may be used to engage with various communications network types. For example, multiple network interfaces 3120 may be employed to allow for the communication over broadcast, multicast, and/or unicast networks.

Input Output interfaces (I/O) 3116 may accept, communicate, and/or connect to user input devices 3124, peripheral devices 3126, cryptographic processor devices 3128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) display port, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 3124 often are a type of peripheral device 3126 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 3126 may be connected and/or communicate to I/O and/or other facilities of the like such as network interfaces 3120, storage interfaces 3122, directly to the interface bus 3118, system bus 3106, the CPU 3104, and/or the like. Peripheral devices 3126 may be external, internal and/or part of the DAD controller 3101. Peripheral devices 3126 may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 3128), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the DAD controller 3101 may be embodied as an embedded, dedicated, and/or monitor-less (i.e., headless) device, wherein access would be provided over a connection to network interface 3120.

Cryptographic unit 3112 such as, but not limited to, microcontrollers, processors 3104, interfaces 3118, and/or devices 3124 may be attached, and/or communicate with the DAD controller 3101. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units 3112 support the authentication of communications from interacting agents, as well as allowing for anonymous transactions. Cryptographic units 3112 may also be configured as part of the CPU 3104. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the DAD controller 3101 and/or a computer systemization 3102 may employ various forms of memory. For example, a computer systemization 3102 may be configured wherein the operation of on-chip CPU memory (e.g., registers), RAM 3108, ROM 3110, and any other storage devices are provided by a paper punch tape or paper punch card mechanism; however, such an embodiment would result in an extremely slow rate of operation. In a typical configuration, memory will include ROM 3110, RAM 3108, and a storage device 3140. The storage device 3140 may be any conventional computer system storage. Storage device 3140 may include: an array of devices (e.g., Redundant Array of Independent Disks (RAID)); a drum; a (fixed and/or removable) magnetic disk drive; a magneto-optical drive; an optical drive (i.e., BLUERAY, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization 3102 generally requires and makes use of one or more such types of memory.

### Component Collection

The storage device 3140 may contain a collection of program and/or database components and/or data such as, but not limited to: operating system component(s) 3113 (operating system); information server component(s) 3172 (information server); user interface component(s) 3175 (user interface); Web browser component(s) 3174 (Web browser); DAD database(s) 3150; mail server component(s) 3171; mail client component(s) 3173; cryptographic server component(s) 3170 (cryptographic server); the DAD component(s) 3142; and/or the like (i.e., collectively a component collection). These components may be stored and accessed from the storage devices and/or from storage devices accessible through an interface bus. Although non-conventional program components such as those in the component collection, typically, are stored in a local storage device 3140, they may also be loaded and/or stored in memory such as: peripheral devices 3126, RAM 3108, remote storage facilities through a communications network 3130, ROM 3110, various forms of memory, and/or the like.

### Operating System

The operating system component 3113 is an executable program component facilitating the operation of the DAD controller 3101. Typically, the operating system facilitates component 3113 access of I/O 3116, network interfaces 3120, peripheral devices 3162, storage devices 3140, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system component 3113 may communicate to and/or with other components in a component collection, including itself, and/or the like. Most frequently, the operating system component 3113 communicates with other program components, user interfaces, and/or the like. For example, the operating system component 3113 may contain, communicate, generate, obtain, and/or provide program component, system, user, and/or data communications, requests, and/or responses. The operating system component 3113, once executed by the CPU 3104, may enable the interaction with communications networks 3130, data, I/O 3116, peripheral devices 3126, program components, memory, user input devices 3124, and/or the like. The operating system component 3113 may provide communications protocols that allow the DAD controller 3101 to communicate with other entities through a communications network 3130. Various communication protocols may be used by the DAD controller 3101 as a subcarrier transport mechanism for interaction, such as, but not limited to: multicast, TCP/IP, UDP, unicast, and/or the like.

### Information Server

An information server component 3172 is a stored program component that is executed by a CPU 3104. The information server component 3172 may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server component 3172 provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the DAD controller 3101 based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server component 3172 may communicate to and/or with other components in a component collection, including itself, and/or facilities of the like. Most frequently, the information server communicates with the DAD database 3150, operating systems, other program components, user interfaces, Web browsers, and/or the like.

Access to the DAD database 3150 may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the DAD. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the DAD as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome; Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 3175 is a stored program component that is executed by a CPU 3104. The user interface component 3175 may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface component 3175 provides a facility through which users may affect, interact, and/or operate a computer system. A user interface may communicate to and/or with other components in a component collection, including itself, and/or facilities of the like. Most frequently, the user interface component 3175 communicates with operating systems, other program components, and/or the like. The user interface may contain, communicate, generate, obtain, and/or provide program component, system, user, and/or data communications, requests, and/or responses.

### Web Browser

A Web browser component 3174 is a stored program component that is executed by a CPU 3104. The Web browser component 3174 may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser component 3174 may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser component 3174 and information server component 3172, a combined application may be developed to perform similar operations of both. The combined application would similarly affect the obtaining and the provision of information to users, user agents, and/or the like from the DAD enabled nodes. The combined application may be nugatory on systems employing standard Web browsers.

### Mail Server

A mail server component 3171 is a stored program component that is executed by a CPU 3104. The mail server may be a conventional Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server component 3171 may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server component 3171 can route, forward, and process incoming and outgoing mail messages that have been sent, relayed and/or otherwise traversing through and/or to the DAD.

Access to the DAD mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 3173 is a stored program component that is executed by a CPU 3104. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 3170 is a stored program component that is executed by a CPU 3104, cryptographic processor 3112, cryptographic processor interface 3114, cryptographic processor device 3128, and/or the like. Cryptographic processor interfaces 3114 will allow for expedition of encryption and/or decryption requests by the cryptographic component; however, the cryptographic component, alternatively, may run on a conventional CPU. The cryptographic server component 3170 allows for the encryption and/or decryption of provided data. The cryptographic server component 3170 allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the DAD may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the DAD component to engage in secure transactions if so desired. The cryptographic component facilitates the secure accessing of resources on the DAD and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The DAD Database

The DAD database component 3150 may be embodied in a database and its stored data. Such database is a stored program component, which is executed by the CPU 3104; the stored program component portion configuring the CPU 3104 to process the stored data. The DAD database component 3150 may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the DAD database component 3150 may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the DAD database 3150 is implemented as a data-structure, the use of the DAD database 3150 may be integrated into another component such as the DAD component 3142. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database 3150 includes several tables 3151-3159:

A Financial Database 3151 includes fields related to financial transaction performed by various Subjects being monitored by to DAD System, such as (but not limited to): transactionID, accountID, assetIDs, deviceIDs, paymentIDs, transactionIDs, userID, transactionType, transactionDate, transactionAmount, transactionQuantity, transactionDetails, transactionNo, transactionAccessPrivileges, transactionPreferences, transactionRestrictions; merchantID, merchantTaxID, merchantName, merchantContactUserID, merchantEmail, merchantAddress, merchantState, merchantZIPcode, merchantCountry, merchantAuthKey, merchantIPaddress, merchantURLaccessCode, merchantPortNo, merchantAccessPrivileges, merchantPreferences, merchantRestrictions, and/or the like;

Fraudulent Transaction Database 3152 includes fields related to known historical fraudulent financial transactions of the population at large, including but not limited to: FraudulentTransactionType, fraudulentTransactionDate, fraudulentTransactionAmount, fraudulentTransactionDetails, and/or the like;

A Subject Database 3153 includes fields related to the Subjects being monitored by the DAD System, such fields including, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

An Observer Database 3154 includes fields related to the Observers charged with monitoring a Subject in the DAD System. Such fields may include, but are not limited to: observerID, observerOwnerID, observerContactID, assetIDs, deviceIDs, paymentIDs, transactionIDs, userIDs, observerType (e.g., agent, entity (e.g., corporate, non-profit, partnership, etc.), individual, etc.), observerCreationDate, observerUpdateDate, observerName, observerAddress, observerState, observerZIPcode, observerCountry, observerEmail, observerPhone, observerAuthKey, observerIPaddress, observerURLAccessCode, observerPortNo, observerAuthorizationCode, observerAccessPrivileges, observerPreferences, observerRestrictions, and/or the like.

A Communication Database 3155 may include fields related to stored communications between the DAD System, Observers and subjects. Such fields may include, but are not limited to: communicationID, accountID, assetIDs, deviceIDs, SubjectIDs, communicationIDs, ObserverID, communicationType, communicationDate, communicationAddressee, communicationSource, communicationContent; and/or the like;

An Administrator Database 3156 may include fields related to DAD System administrator information, such as, but not limited to: adminID, adminEmployeeID, admineName, adminContactUserID, adminEmail, adminAddress, adminState, adminZIPcode, adminCountry, adminAuthKey, adminIPaddress, adminURLaccessCode, adminPortNo, adminAccessPrivileges, adminPreferences, adminRestrictions, and/or the like;

A users table 3157 includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (note, the user table 3157 may support and/or track multiple entity accounts on the DAD);

An devices table 3158 includes fields such as, but not limited to: deviceID, accountID, assetIDs, paymentIDs, deviceType, deviceName, deviceModel, deviceVersion, deviceSerialNo, devicelPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, device Preferences, deviceRestrictions, and/or the like;

An apps table 3159 includes fields such as, but not limited to: appID, appName, appType, appDependencies, accountID, deviceIDs, transactionID, userID, appStoreAuthKey, appStoreAccountID, appStorelPaddress, appStoreURLaccessCode, appStorePortNo, appAccessPrivileges, appPreferences, appRestrictions and/or the like;

In one embodiment, the DAD database 3150 may interact with other database systems. For example, employing a distributed database system, queries and data access by search DAD component 3142 may treat the combination of the DAD database 3150, an integrated data security layer database as a single database entity.

In one embodiment, user programs may contain various user interface primitives, which may serve to update the DAD. Also, various accounts may require custom database tables depending upon the environments and the types of clients the DAD may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 3151-3159 The DAD may be configured to keep track of various settings, inputs, and parameters via database controllers.

The DAD database 3150 may communicate to and/or with other components in a component collection, including itself, and/or facilities of the like. Most frequently, the DAD database 3150 communicates with the DAD component 3142, other program components, behaviorial data sources 585 and/or the like. The database may contain, retain, and provide information regarding other nodes and data.

### The DADs

The DAD component 3142 is a stored program component that is executed by a CPU 3104. In one embodiment, the DAD component 3142 incorporates any and/or all combinations of the aspects of the DAD that was discussed in the previous figures. As such, the DAD affects accessing, obtaining and the provision of information, services, transactions, and/or the like across various communications networks. The features and embodiments of the DAD discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the DAD's features and facilities, and in many cases reduce the costs, energy consumption/requirements, and extend the life of DAD's underlying infrastructure; this has the added benefit of making the DAD more reliable. Similarly, many of the features and mechanisms are designed to be easier for users to use and access, thereby broadening the audience that may enjoy/employ and exploit the feature sets of the DAD; such ease of use also helps to increase the reliability of the DAD. In addition, the feature sets include heightened security as noted via the Cryptographic components 3170 and throughout, making access to the features and data more reliable and secure

The DAD transforms abnormal financial or behavioral pattern and enrollment request message inputs, via DAD automated software components (e.g., Enrollment Component, Financial Transaction and Behavioral Tracking Component, and Alerting Component 3162), into alert outputs. The Enrollment Component 3160 manages the enrollment of Subjects and Observers in the manners described herein, by collecting all the Subject and Observer contact and financial information needed over data communications networks. The Monitoring Component 3161 monitors the financial transaction data received from financial institution servers 112 received over data communications networks to determines whether any Subject transactions have fraudulent transaction indicators. The Alerting Component 3162 determines a level of fraud that may be indicating regarding a particular Subject financial transaction and generate alerts that may be sent to Observers, Administrators, financial institution representatives, and other third parties as described herein. The Admin component 3163 determines all interactions between an administrator of the DAD System and the DAD system itself (i.e., rights and privileges of the administrator, a log of administrator activities, communications from the Administrator to Observers and Subjects, and the like). The Reporting Component 3164 determines reports on the usefulness of the DAD System in preventing fraud or the like. As such the Reporting Components may generate periodic reports for use by Administrators and the like in determining the number of financial transactions successfully prevented, the dollar amounts involved in such attempted fraudulent transactions, as well as the number of false positive transactions and actions that may be taken to prevent future false positives. Finally, a Prediction Component 3165 determines predictive indicators for fraudulent transactions involving Subjects. The predictive indicators may be determined from the historical purchasing and financial behaviors of a subject, information from known historical fraudulent transactions and/or other aberrant behavioral data of the population at large, the changes in recent behavior of a given Subject and further information as described herein above.

The DAD component 3142 enabling access of information between nodes as described herein may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the DAD server 3101 may employ a cryptographic server 3112 to encrypt and decrypt communications. The DAD component 3142 may communicate to and/or with other components in a component collection, including itself, and/or facilities of the like. Most frequently, the DAD component 3142 communicates with the DAD database 3150, operating systems 3113, other program components, and/or the like. The DAD may contain, communicate, generate, obtain, and/or provide program component, system, user, and/or data communications, requests, and/or responses.

### Distributed DADs

The structure and/or operation of any of the DAD node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the DAD in implementation will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the DAD controller 3101 may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of message
do {
    $input = “”;
    $input = socket_read($client, 1024);
    $data .= $input;
}while($input != “”);
// parse data to extract variables
$obj = json_decode($data, true);
// store input data in a database
mysql_connect(“201.408.185.132”,$DBserver,$password); // access database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

### Example of the DAD System in Use

Jen describes herself to her friends as “a mother to three boys including her husband” and she's the one in the family who makes the plans, pays the bills, and keeps the day-to-day necessities in order. Jen lives in San Franscisco, Calif., working as a Senior Director at a large software firm, and whatever spare time her family life offers her is filled up with career obligations. She does not mind—Jen loves her job—but sometimes it's a too much to track all of the little things.

This has become especially true of late, where Jen's mother hasn't been doing so well lately, especially since the passage of dad. Mom's health is deteriorating rapidly, and Jen has had to hire an assistant to check in on mom three times a day.

Always the responsible one in the family, Jen is appointed as the executor of her mother's will, and generally is the one her mom taps for help with financial matters. Jen keeps her money at one financial institution, but her dad had always kept the family's money with another financial institution. Since Dad died, Jen has thought about consolidating the funds, but hasn't really given it the time to transfer everything, and is getting increasingly anxious about her mother's well-being.

Jen wouldn't worry quite so much, but her mom lives out in Boca Raton, and it's tough to keep track of her day-to-day affairs. Moreover, Jen has never met the assistant living in the home, and she wishes that she could. Jen is a trusting person, but this is a complete stranger going into and out of the house, and she wishes there was a little more oversight.

Jen is delighted when she gets a mailing from her financial institution about a new product that helps elders manage their finances. The service essentially tracks Mom's behaviors, and will alerts Jen if there is anything abnormal going on. Jen thinks of it like credit card risk services on steroids—instead of just tracking based on Mom's location or normal spending patterns, it also tracks for unusual activity, such as large withdrawals from a savings or investment account, and compares Mom's activities to millions of others to unearth shady behavior before it can happen.

When something goes wrong, Jen is alerted through a series of channels, depending on the severity or immediacy of the problem. These range from an email, to a phone alert, to a call from a financial institution representative. Jen is comforted by the fact that she can also configure the system to contact Mom's Doctor, or a lawyer, or other caregivers that might have good insight into the situation.

So Jen decides to sign up for the DAD service, after discussing it with her mom. Because her mom is already a customer of the financial institution, it's very quick and easy. Jen may simply go on her user device, such as a smartphone, and install the DAD app provided by the financial institution. It walks Jen through a quick and simple series of steps, naming out herself and her mom's contact information. She sees that she can add another number of people, and specify who gets alerts for which particular types of problems. Jen quickly creates her own profile, selecting herself for all of the possible issues that could arise, and then adds in her brother to see a specific subset of information.

Later that week, Jen gets her mom to Skype with her using mom's tablet, and Jen fills out the rest of the profile. Jen's mom allows Jen to set a “fund withdrawal limit” so large sums of money cannot be moved without Jen's approval. This includes her doctor's information, and her credit cards. Ordinarily, Jen wouldn't trust a brand with this information, but her financial institution has reassured her that everything is incredibly secure, and this information will prevent serious problems down the road. After enrollment, Jen gets a notification from the financial institution that everything is set up and running.

Initially, things are going smoothly, and Jen gives it almost no thought—it's nearly effortless! If Jen's mom chooses, Jen can track her mom's spending patterns and behaviors, seeing a list of bills due and balances to pay them. The system can alert Jen's mom to pay a given bill, or even offer her the ability to use a billpay feature to cover costs. Jen occasionally checks the app to see how things are doing, but overall does not worry.

One day, however, Jen gets a phone call from a phone number she does not know. She's in a meeting, so she ignores it. However, she then sees a simultaneous alert on her tablet, and an email from the financial institution, saying that there is an urgent issue and could she please call. Jen ducks out of her office and taps the “call now” button on the tablet. It dials her phone so while she's looking at the alert details. Her brother has also gotten a notification, and shoots Jen an email to find out if everything is ok.

It appears that Jen's mom is at the local branch with an unknown stranger, trying to take out a sum of money. The stranger never left Mom's side, but it was pretty clear that Mom seemed anxious and confused. The representatives explained that Mom had signed up for DAD Protection, and that there would need to be validation from Mom's guardian. They go to ask for the stranger's information, but the individual has left.

Jen calls her mom that night to see what is going on, and mom is upset. It appears that the assistant tried to coerce Mom into taking out a large sum of money, under the guise of an upfront payment. Mom wasn't sure if that was the right thing to do, but decided to pretend it was a normal behavior. Jen, having set up the arrangement with the assistant's employer, is 100% positive that it isn't, and fires the assistant the next morning. Thankfully, the money never left the system. The incident stays in the app view, notifying when both Jen and her brother saw it, and when it was resolved.

The financial institution sends a registered mail to Jen with a description of the incident, and the actions taken to protect the money. Jen uses this to prevent any termination fees with the assistant's employer, and documents the assistant's behavior, thereby getting this individual away from people he can prey on.

Jen is so impressed with the service that she decides to keep her mom's money there, and even goes so far to talk with her accountant about moving her funds over as well. The security the app offers is one less thing for her to worry about, and anything that can simplify her life is great news.

In order to address various issues and advance the art, the entirety of this application for Aberrant and Diminished Activity Detector Apparatuses, Methods and Systems (including the Cover Page, Tide, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a DAD individual and/or enterprise user, database configuration and/or relational model, data type, data transmission and/or network framework, syntax structure, and/or the like, various embodiments of the DAD, may be implemented that enable a great deal of flexibility and customization. For example, aspects of the DAD may be adapted for monitoring other types of behaviors aside from financial transaction. While various embodiments and discussions of the DAD have included Fraud Detection and Prevention, however, it is to be understood that the embodiments described herein may be readily configured and/or customized for a wide variety of other applications and/or implementations.

1. A financial transaction monitoring and alerting apparatus, comprising:
a memory;
a component collection in the memory, including:
an enrollment component, and
a monitoring component;
a processor disposed in communication with the memory, and configured to issue a plurality of processing instructions from the component collection stored in the memory,
wherein the processor issues instructions from the enrollment component, stored in the memory, to:
obtain an enrollment of a subject via the enrollment component from enrollment information provided by one of the subject and an observer via a user device in communication with the apparatus;
determine abnormal transaction indicators for the subject from at least one of: historical financial transaction patterns of the subject, abnormal behavior patterns of the subject and predictive indicators derived from historical fraudulent financial data of a population;
establish, via the processor, transaction alarm thresholds based on the abnormal transaction indicators.
wherein the processor issues instructions from the monitoring component, stored in the memory, to:
obtain an indication of a financial transaction involving the subject via the monitoring component from financial transaction data provided by financial institution servers via a financial transaction network,
determine an alert level for the financial transaction by comparing details of the financial transaction to the transaction alarm thresholds; and
transmit an alert to an enrolled observer in accordance with the determined alert level.

2. The apparatus of claim 1, wherein the alert level comprises one of plurality of alert levels, wherein each alert level requires a differing response from at least one of observers and third parties.

3. The apparatus of claim 1, further, comprising:
the processor issues instructions from the monitoring component, stored in the memory, to:
display the determined alert to at least one of observers and third parties.

4. A processor-readable financial transaction monitoring medium storing processor-executable components, the components comprising:
a component collection stored in the medium, including:
an enrollment component, and
an monitoring component;
wherein the enrollment component, stored in the medium, includes processor-issuable instructions to:
obtain an enrollment of a subject via the enrollment component from enrollment information provided by one of the subject and an observer via a user device;
determine abnormal transaction indicators for the subject from at least one of: historical financial transaction patterns of the subject, abnormal behavior patterns of the subject and predictive indicators derived from historical fraudulent financial data of a population;
establish, via the processor, abnormal transaction alarm thresholds based on the abnormal transaction indicators.
wherein the monitoring component, stored in the medium, includes processor-issuable instructions to:
obtain an indication of a financial transaction involving the subject via the monitoring component from financial transaction data provided by financial institution servers via a financial transaction network,
determine an alert level for the financial transaction by comparing details of the financial transaction to the abnormal transaction alarm thresholds; and
provide an alert to an enrolled observer in accordance with the determined alert level.

5. A processor-implemented alert system, comprising:
a enrollment component means, to:
obtain an enrollment of a subject via the enrollment component from enrollment information provided by one of the subject and an observer via a user device in communication with the apparatus;
determine abnormal transaction indicators for the subject from at least one of:
historical financial transaction patterns of the subject, abnormal behavior patterns of the subject and predictive indicators derived from historical fraudulent financial data of a population;
establish, via the processor, abnormal transaction alarm thresholds based on the abnormal transaction indicators.
monitoring component means, to:
obtain an indication of a financial transaction involving the subject via the monitoring component from financial transaction data provided by a plurality of financial institution servers from differing financial institutions via a financial transaction network,
determine an alert level for the financial transaction by comparing details of the financial transaction to the abnormal transaction alarm thresholds; and
provide an alert to an enrolled observer in accordance with the determined alert level.

6. A processor-implemented alert method to transform enrollment and monitoring inputs into actionable alerts, comprising:
executing processor-implemented enrollment component instructions to:
obtain an enrollment of a subject via the enrollment component from enrollment information provided by one of the subject and an observer via a user device in communication with the apparatus;
determine abnormal transaction indicators for the subject from at least one of: historical financial transaction patterns of the subject, abnormal behavior patterns of the subject and predictive indicators derived from historical fraudulent financial data of a population;
establish, via the processor, abnormal transaction alarm thresholds based on the abnormal transaction indicators.
executing processor-implemented monitoring component instructions to:
obtain an indication of a financial transaction involving the subject via the monitoring component from financial transaction data provided by a plurality of financial institution servers from differing financial institutions via a financial transaction network,
determine an alert level for the financial transaction by comparing details of the financial transaction to the abnormal transaction alarm thresholds; and
provide an alert to an enrolled observer in accordance with the determined alert level.

7. A financial transaction monitoring system, comprising:
a network communications unit to receive subject enrollment inputs via a user terminal; operated by an observer of the subject;
an enrollment storage component to
store the subject enrollment inputs;
determine abnormal transaction indicators for a subject related to the subject enrollment inputs from at least one of: historical financial transaction patterns of the subject, abnormal behavior patterns of the subject and predictive indicators derived from historical fraudulent financial data of a population; and
establish abnormal transaction alarm thresholds for the subject based on the abnormal transaction indicators; and
a financial transaction monitoring components to obtain an indication of a financial transaction involving the subject via the monitoring component from financial transaction data provided by a plurality of financial institution servers from differing financial institutions via a financial transaction network;
an alarm determination component to determine an alert level for the financial transaction by comparing details of the financial transaction to the abnormal transaction alarm thresholds; and
an alerting component to provide an alert to an enrolled observer in accordance with the determined alert level.

8. A processor-implemented alert apparatus that transforms enrollment and monitoring inputs into actionable alerts, comprising:
means for obtaining an enrollment of a subject via the enrollment component from enrollment information provided by one of the subject and an observer via a user device in communication with the apparatus;
means for determining abnormal transaction indicators for the subject from at least one of: historical financial transaction patterns of the subject, abnormal behavior patterns of the subject and predictive indicators derived from historical fraudulent financial data of a population;
means for establishing abnormal transaction alarm thresholds based on the abnormal transaction indicators;
means for obtaining an indication of a financial transaction involving the subject via the monitoring component from financial transaction data provided by a plurality of financial institution servers from differing financial institutions via a financial transaction network,
means for determining an alert level for the financial transaction by comparing details of the financial transaction to the abnormal transaction alarm thresholds; and
means for providing an alert to an enrolled observer in accordance with the determined alert level.

9. The apparatus of claim 1, wherein the enrolled observer is a relative of the subject.

10. The apparatus of claim 1, wherein the enrolled observer is a trusted third party designated by the subject.

11. The apparatus of claim 3, wherein one of the third parties is a law enforcement agency.

12. The apparatus of claim 1, wherein one of the third parties is a representative at a location where the financial transaction is occurring.

13. The apparatus of claim 1, wherein the component collection further includes an alerting component, and wherein the processor issues instructions from the alerting component, stored in the memory, to:
obtain the alert and the alert level from the monitoring component;
determine an observer device designated to receive the alert, based on the subject, the alert and the alert level; and
transmit the alert to the observer device in accordance with the determined alert level.

14. The apparatus of claim 13, wherein the processor issues instructions from the alerting component, stored in the memory, to:
receive a response to the alert from the observer device, the response including at least one instruction to allow or reject the financial instruction;
determine the at least one instruction from the response; and
transmit the at least one instruction to a communication device of a representative managing the financial transaction.

15. The apparatus of claim 14, wherein the processor issues instructions from the alerting component, stored in the memory, to:
receive, from the observer device of the enrolled observer, a preference for the transaction alarm threshold, where the transaction alarm threshold is based on at least one of a monetary value of and a frequency of transactions involving the subject;
determine the transaction alarm threshold based on the preference; and
store the alarm transaction threshold in a database for comparison to monitored transactions involving the subject.

16. The apparatus of claim 1, wherein the financial transaction comprises a transfer having a monetary value.

17. The medium of claim 4, wherein the alert level comprises one of plurality of alert levels,
wherein each alert level requires a differing response from at least one of observers and third parties.

18. The medium of claim 4, further, comprising:
the processor issues instructions from the monitoring component, stored in the memory, to:
display the determined alert to at least one of observers and third parties.

19. The medium of claim 4, wherein the enrolled observer is a relative of the subject.

20. The medium of claim 4, wherein the enrolled observer is a trusted third party designated by the subject.

21. The medium of claim 18, wherein one of the third parties is a law enforcement agency.

22. The medium of claim 4, wherein one of the third parties is a representative at a location where the financial transaction is occurring.

23. The medium of claim 4, wherein the component collection further includes an alerting component, and wherein the processor issues instructions from the alerting component, stored in the memory, to:
obtain the alert and the alert level from the monitoring component;
determine an observer device designated to receive the alert, based on the subject, the alert and the alert level; and
transmit the alert to the observer device in accordance with the determined alert level.

24. The medium of claim 23, wherein the processor issues instructions from the alerting component, stored in the memory, to:
receive a response to the alert from the observer device, the response including at least one instruction to allow or reject the financial instruction;
determine the at least one instruction from the response; and
transmit the at least one instruction to a communication device of a representative managing the financial transaction.

25. The medium of claim 24, wherein the processor issues instructions from the alerting component, stored in the memory, to:
receive, from the observer device of the enrolled observer, a preference for the transaction alarm threshold, where the transaction alarm threshold is based on at least one of a monetary value of and a frequency of transactions involving the subject;
determine the transaction alarm threshold based on the preference; and
store the alarm transaction threshold in a database for comparison to monitored transactions involving the subject.

26. The medium of claim 4, wherein the financial transaction comprises a transfer having a monetary value.

27. The system of claim 5, wherein the alert level comprises one of plurality of alert levels,
wherein each alert level requires a differing response from at least one of observers and third parties.

28. The system of claim 5, further, comprising:
the processor issues instructions from the monitoring component, stored in the memory, to:
display the determined alert to at least one of observers and third parties.

29. The system of claim 5, wherein the enrolled observer is a relative of the subject.

30. The system of claim 5, wherein the enrolled observer is a trusted third party designated by the subject.

31. The system of claim 28, wherein one of the third parties is a law enforcement agency.

32. The system of claim 5, wherein one of the third parties is a representative at a location where the financial transaction is occurring.

33. The system of claim 5, wherein the component collection further includes an alerting component, and wherein the processor issues instructions from the alerting component, stored in the memory, to:
obtain the alert and the alert level from the monitoring component;
determine an observer device designated to receive the alert, based on the subject, the alert and the alert level; and
transmit the alert to the observer device in accordance with the determined alert level.

34. The system of claim 33, wherein the processor issues instructions from the alerting component, stored in the memory, to:
receive a response to the alert from the observer device, the response including at least one instruction to allow or reject the financial instruction;
determine the at least one instruction from the response; and
transmit the at least one instruction to a communication device of a representative managing the financial transaction.

35. The system of claim 35, wherein the processor issues instructions from the alerting component, stored in the memory, to:
receive, from the observer device of the enrolled observer, a preference for the transaction alarm threshold, where the transaction alarm threshold is based on at least one of a monetary value of and a frequency of transactions involving the subject;
determine the transaction alarm threshold based on the preference; and
store the alarm transaction threshold in a database for comparison to monitored transactions involving the subject.

36. The system of claim 5, wherein the financial transaction comprises a transfer having a monetary value.

37. The method of claim 6, wherein the alert level comprises one of plurality of alert levels,
wherein each alert level requires a differing response from at least one of observers and third parties.

38. The method of claim 6, further, comprising:
the processor issues instructions from the monitoring component, stored in the memory, to:
display the determined alert to at least one of observers and third parties.

39. The method of claim 6, wherein the enrolled observer is a relative of the subject.

40. The method of claim 6, wherein the enrolled observer is a trusted third party designated by the subject.

41. The method of claim 38, wherein one of the third parties is a law enforcement agency.

42. The method of claim 6, wherein one of the third parties is a representative at a location where the financial transaction is occurring.

43. The method of claim 6, wherein the component collection further includes an alerting component, and wherein the processor issues instructions from the alerting component, stored in the memory, to:
obtain the alert and the alert level from the monitoring component;
determine an observer device designated to receive the alert, based on the subject, the alert and the alert level; and
transmit the alert to the observer device in accordance with the determined alert level.

44. The method of claim 43, wherein the processor issues instructions from the alerting component, stored in the memory, to:
receive a response to the alert from the observer device, the response including at least one instruction to allow or reject the financial instruction;
determine the at least one instruction from the response; and
transmit the at least one instruction to a communication device of a representative managing the financial transaction.

45. The method of claim 46, wherein the processor issues instructions from the alerting component, stored in the memory, to:
receive, from the observer device of the enrolled observer, a preference for the transaction alarm threshold, where the transaction alarm threshold is based on at least one of a monetary value of and a frequency of transactions involving the subject;
determine the transaction alarm threshold based on the preference; and
store the alarm transaction threshold in a database for comparison to monitored transactions involving the subject.

46. The method of claim 6, wherein the financial transaction comprises a transfer having a monetary value.
